(19) United States
(12) Patent Application Publication
(10) Pub. No.: US 2010/0332281 A1
(43) Pub. Date: Dec. 30, 2010

(54) TASK ALLOCATION MECHANISMS AND MARKETS FOR ACQUIRING AND HARNESSING SETS OF HUMAN AND COMPUTATIONAL RESOURCES FOR SENSING, EFFECTING, AND PROBLEM SOLVING

(75) Inventors: Eric Horvitz, Kirkland, WA (US); Dafna Shahaf, Pittsburgh, PA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/493,146

(22) Filed: Jun. 26, 2009

(51) Int. Cl. G06Q 10/00

(52) U.S. Cl. 705/9; 705/11

(57) ABSTRACT

A set of projects may be defined, each project having a set of tasks to be performed. In turn, each task may be mapped to a set of task capabilities that are involved in completing the task. A set of agents and components (potentially including both human agents and automated agent, and components for sensing and effecting action in the world) may also be defined, and each agent may have a set of agent capabilities representing skills, knowledge, resources, relationships, etc., that an agent may commit to a task. The tasks of the projects may be fulfilled by identifying coalitions of agents for respective tasks, featuring a sufficient set of agent capabilities corresponding to the task capabilities. This model may be used, e.g., in a matching service, whereby projects submitted by managers may be completed through an automated matching of tasks with a set of agents subscribing to the service.

### BACKGROUND

Many computing scenarios involve an allocation of resources capable of performing the tasks associated with a project. For example, a manager of a software project may manage the identification of a set of components comprising the architecture of the project, and may allocate individuals in a team of software developers to contribute to various components. A project manager may also use a software tool, such as a project management package, to represent the set of individuals and the set of projects, and to assign individuals to projects. Alternatively, a database of projects to be completed may be devised, and individuals may browse the database for projects consistent with their skills and interests, and may accept and accomplish various portions of such projects.

### SUMMARY

This Summary is provided to introduce a selection of concepts in a simplified form that are further described below in the Detailed Description. This Summary is not intended to identify key factors or essential features of the claimed subject matter, nor is it intended to be used to limit the scope of the claimed subject matter.

The assignment of individuals and resources to projects may be complicated by many factors. As a first example, individuals may have different capabilities, and may vary by proficiency in such capabilities. As a second example, the resources may include automated processes of different capabilities and proficiencies thereof, and the allocation may involve selecting a diverse set of individuals and automated processes for various projects. As a third example, a project may have several tasks to be completed, and such tasks may vary in terms of the requisite capabilities for performing the task. As a fourth example, the tasks may have an order of precedence, such that a first task may only be performed after a second task is completed. As a fifth example, there may be many ways to perform a task; e.g., a task may be decomposed into a set of task states, and many paths among the states may be available between the start state and the completed state of the task. Moreover, different requisite capabilities may be involved in transitioning between two task states, and two different paths through the task states may be achieved that involve very different sets of capabilities of the individuals and automated processes. As a sixth example, the allocation may be performed in pursuit of many preferences of the project manager, e.g., maximizing the quality of the performance of the project; minimizing costs or staying within a budget; minimizing the project completion time or meeting a deadline; minimizing the set of allocated resources or avoiding an inefficient commitment of resources; and maximizing the reliability of the performance of the project.

Moreover, the set of projects may be large; respective projects may involve a large set of tasks, and each task may have a potentially large set of task states and paths thereamong for performing the task; and the tasks may call for a large or diverse set of capabilities. Similarly, the set of human and automated agents allocated to such tasks may be large, and each agent may have a distinctively different set of capabilities and proficiencies thereamong. Therefore, the computational resources involved in matching agents to tasks may be a computationally difficult problem, due to the sizable number of available combinations and allocations of resources. Therefore, it may be difficult for the project manager to allocate resources to tasks in a manner that maximizes the conformity of the allocation with the preferences of the project manager.

Presented herein are techniques for selecting and comparing allocations of agents to the projects and tasks in an automated manner and taking into account the various properties and conditions of such allocations. These techniques involve modeling respective agents as having various agent capabilities, and modeling various tasks of the projects as having various requisite task capabilities. A matching process may be performed by selecting a coalition of agents for respective tasks, where the set of agent capabilities presented by the agents of the coalition satisfies the set of task capabilities of a task. Once a coalition may be identified with a suitably high utility (e.g., a high work quality, a quick or inexpensive performance of the task, or a minimum of unused agent capabilities in the coalition), the coalition of agents may be allocated to the task, and the agents may be removed from the pool of available agents. This matching may continue until all of the tasks have been allocated a suitable coalition of agents.

Refinements of these techniques may also be implemented to achieve additional advantages. As a first example, upon identifying a human agent having at least one agent capability corresponding to a task capability, the task may be offered to the human agent, who may or may not opt to accept the task. The human agent may be rewarded for accepting and completing the task; for example, the human agent may be paid, or the task may be formulated as a game dependent on the agent capability and awarding points or other in-game rewards for completing the task. As a second example, a manager who wishes to perform a particular project may select a project template with a predefined set of tasks; alternatively, the manager may specify the tasks comprising the template, or the tasks of a project may be deduced from contextual factors. As a third example, the matching may be configured to optimize particular aspects of the allocation of coalitions. For example, agents may specify costs for performing various tasks, and the matching may be configured to maintain a low aggregate cost; or the agent capabilities of an agent may have different proficiencies, and the matching may be configured to achieve a high aggregate proficiency of performed tasks; or the matching may be configured to preferentially select a lower number of agents for a task, or to allocate agents redundantly to a task, in order to promote dependability. As a fourth example, matching techniques may also be devised with a reduced computational burden in order to conserve computing resources and produce results in an acceptable time frame. These and other refinements may be implemented to confer further advantages on embodiments of these techniques.

To the accomplishment of the foregoing and related ends, the following description and annexed drawings set forth certain illustrative aspects and implementations. These are indicative of but a few of the various ways in which one or more aspects may be employed. Other aspects, advantages, and novel features of the disclosure will become apparent from the following detailed description when considered in conjunction with the annexed drawings.

### DESCRIPTION OF THE DRAWINGS

FIG. 1 is an illustration of an exemplary scenario featuring a project set and an agent set to be allocated to tasks of the projects of the project set by a manager.

FIG. 2 is an illustration of exemplary allocations of the agent set to the tasks of the project set of FIG. 1.

FIG. 3 is an illustration of a technique for allocating agents of an agent set to perform tasks of projects of a project set.

FIG. 4 is a flow chart illustrating an exemplary method of allocating an agent set to perform tasks of projects in a project set.

FIG. 5 is a component block diagram illustrating an exemplary system for allocating an agent set to perform tasks of projects in a project set.

FIG. 6 is an illustration of an exemplary computer-readable medium comprising processor-executable instructions configured to embody one or more of the provisions set forth herein.

FIG. 7 is an illustration of an exemplary scenario featuring creation of a project according to a project template.

FIG. 8 is an illustration of an exemplary scenario featuring a presentation to a manager of agents in an agent database suitable for allocation to the tasks of a project.

FIG. 9 is an illustration of an exemplary scenario featuring a presentation of a game to an agent in order to facilitate the performance of a task.

FIG. 10 is an illustration of a set of sensory agents identified by a resource broker and allocated to fulfill a task involving sensory agent capabilities.

FIG. 11 is an illustration of a set of effector agents identified by a resource broker and allocated to fulfill a task involving effector agent capabilities.

FIG. 12 is a component block diagram illustrating another exemplary system for allocating an agent set to perform tasks of projects in a project set.

FIG. 13 is an illustration of an exemplary scenario featuring an allocation of capability capacities of agent capabilities of various agents to satisfy corresponding capability consumptions of task capabilities of various tasks.

FIG. 14 is an illustration of an exemplary scenario featuring an exemplary set of tasks.

FIG. 15 is an illustration of an exemplary scenario featuring three alternative completions of the task of FIG. 14 through various task states.

FIG. 16 illustrates an exemplary computing environment wherein one or more of the provisions set forth herein may be implemented.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, structures and devices are shown in block diagram form in order to facilitate describing the claimed subject matter.

Within the field of computing, many scenarios involve an allocation of resources (such as human agents and computational capabilities) to a set of projects, where each project involves a set of tasks. As a first example, a project manager may supervise a team of software developers, and may be responsible for developing a software project. The project manager may therefore establish with the team a software architecture comprising a set of interrelated modules, and may allocate the team of software developers to develop the modules. Moreover, different modules may utilize different technologies, and may involve different skills (e.g., an application front end may involve visual design and applications programming skills; a database back end may involve database design and procedural programming skills; and a multimedia library may involve graphical design and music design skills.) The project manager may therefore endeavor to allocate the software developers to the modules according to the skill set of each developer and the requisite skills of each task.

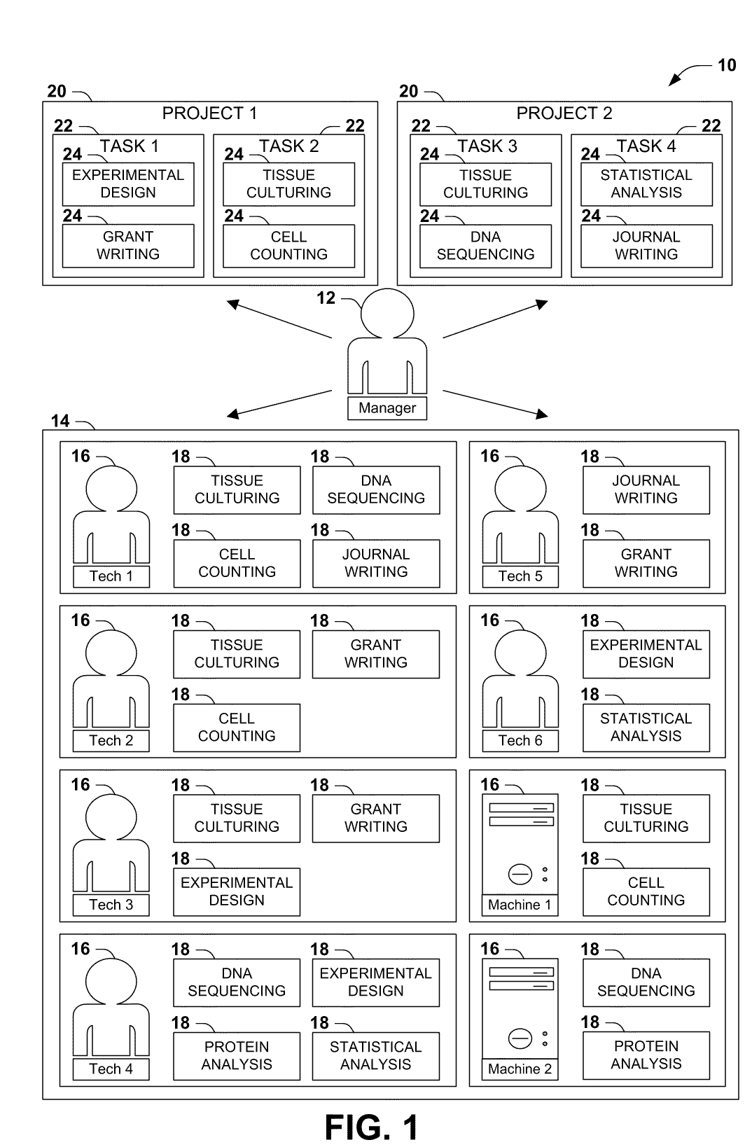

FIG. 1 presents a second example, illustrating an exemplary scenario 10 involving a manager 12 of a laboratory who is responsible for allocating a set of laboratory resources to fulfill various tasks of pending research projects. The manager 12 may be responsible for an agent set 14, comprising agents 16 who are capable of performing various laboratory duties. The agents 16 in this exemplary scenario 10 include both human agents (i.e., laboratory technicians skilled in various laboratory duties) as and automated agents (i.e., laboratory equipment that can perform various laboratory duties.) Each agent 16 in the agent set 14 is represented with a set of agent capabilities 20, selected from a set of laboratory duties (including experimental design, grant writing, statistical analysis, journal writing, tissue culturing, cell counting, DNA sequencing, and protein analysis.) In addition, the manager 12 may manage a set of projects 20 representing the currently pending research projects and experiments. Each project 20 may comprise a set of tasks 22 for performing the project 20. Moreover, each task 22 involves a particular set of task capabilities 22, representing the requisite skills that an agent 16 utilizes while performing the task 22.

In this exemplary scenario 10 of FIG. 1, the manager 12 is tasked with allocating the agents 16 of the agent set 14 to perform the tasks 22 of the respective projects 20. Moreover, in this simplified exemplary scenario 10, an agent 16 may only be allocated to one task 22. Therefore, the manager 12 may endeavor to allocate the agents 16 of the agent set 14 as efficiently as possible to cover the task capabilities 24 of all tasks 22 for all projects 20. However, many allocations may be satisfactory, but may present comparative advantages and disadvantages.

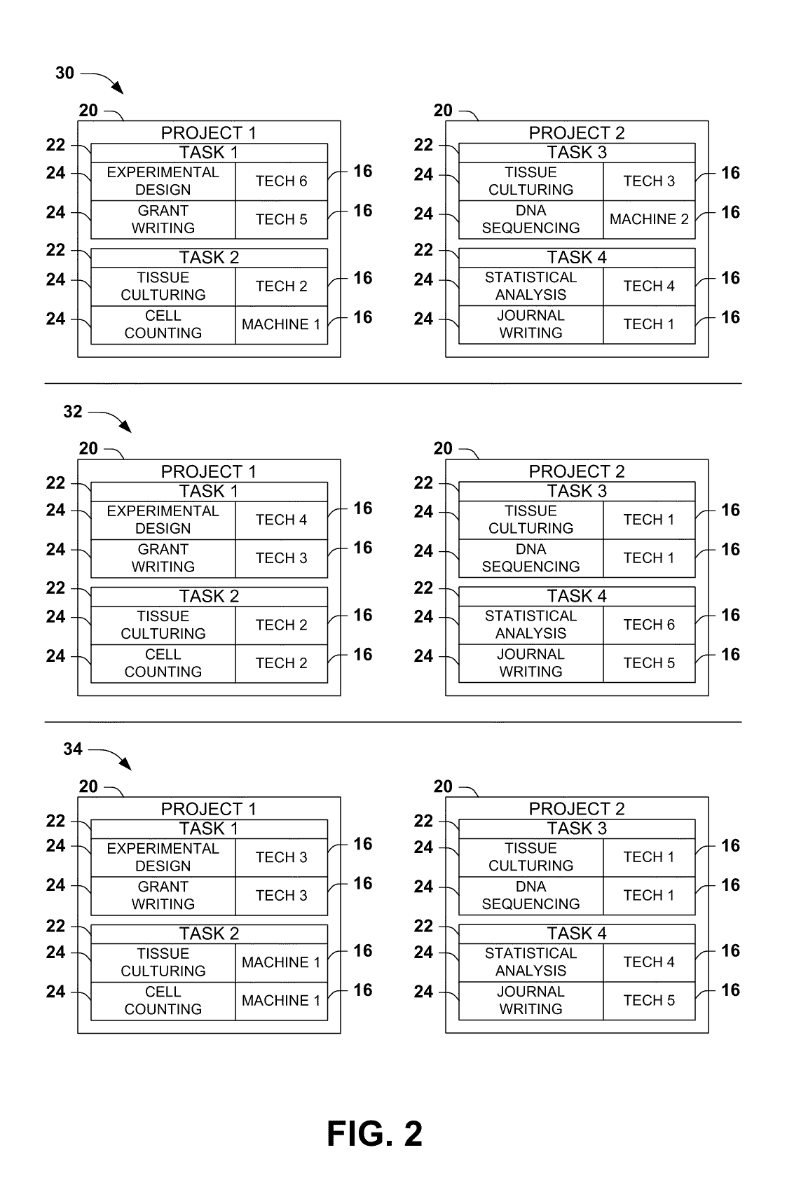

FIG. 2 illustrates three exemplary allocations of the agents 16 of the agent set 14 to the projects 20 and tasks 22 of FIG. 1. In a first allocation 30, each task 22, having two task capabilities 24, may be allocated a team of two agents 16 that comprise the task capabilities 24. This allocation may be advantageous because the agents 16 of the agent set 14 may be fully utilized, and with this maximum allocation of resources, the projects 20 may therefore be completed in a desirably short time frame, which may be preferred by the manager 12. However, competing interests may also be involved that present comparative disadvantages. For example, it may be desirable to use human agents over automated agents, which may be more expensive to operate or less proficient at performing the capabilities than laboratory technicians. It might also be desirable to utilize human agents in order to confer experience and improve laboratory skills through practice. A second allocation 32 may therefore be prepared where human agents may be preferentially allocated to the tasks 22 over automated agents. For example, the second task 22 comprises two task capabilities 24 (tissue culturing and cell counting) that are both possessed by the second laboratory technician, and the third task 22 comprises two task capabilities 24 (tissue culturing and DNA sequencing) that are both possessed by the first laboratory technician. Therefore, these two tasks 22 may be wholly performed by the respective agents 16, thereby leaving the laboratory equipment unallocated as a cost savings or a quality of work improvement. Alternatively, the manager 12 may prefer to utilize as few agents 16 as possible, thereby freeing agents 16 to take on additional projects 20 (even if each project 20 takes longer to complete.) Therefore, a third allocation 34 may be devised with an emphasis on reducing the number of agents 16 so allocated. In this third allocation 34, the first three tasks 22 may each be performed by one agent 16 having both of the agent capabilities 18 corresponding to the task capabilities 24 of the task 22, while the fourth task 22 again utilizes two agents 16. This third allocation 34 thereby frees two human agents and one automated agent for deployment to other projects 20.

It may be appreciated from FIG. 2 that many such allocations may be available between the agents 16 of an agent set 14 and a set of tasks 22 for respective projects 20. Moreover, various preferences (e.g., maximizing or minimizing the number of agents 16, or preferentially allocating particular agents 16 over other agents 16) may be factored into the allocation in pursuit of various interest (e.g., expediting project completion, maximizing quality of work, reducing costs, or freeing agents 16 for other tasks.) It may be difficult to select an allocation that successfully balances the preferences and interests. This allocation may become even more difficult with increasing numbers of agents 16, projects 20, tasks 22, and agent capabilities 18 to be matched with task capabilities 24.

Even more complexities may arise as the scenario becomes more complex. As a first example, particular tasks 22 might be performed only after the completion of one or more predecessor tasks 22 (e.g., in the third task 22 of the second project 20 of FIGS. 1-2, tissue culturing may have to be completed before DNA sequencing.) If the manager 12 is interested in expediting throughout, the allocations may have to account for this sequencing of tasks 22 in order to reduce delays. As a second example, an agent 16 may have agent capabilities 18 of different proficiencies, and it may be desirable to allocate agents 16 who may perform particular tasks 22 with high proficiency in order to promote a greater aggregate quality of work. As a third example, different costs may be involved for utilizing an agent capability 18 of an agent 16, and the manager 12 may prefer to allocate the agents 16 to the tasks 22 in a manner that reduces costs (or at least remains within the budget of the laboratory.) As a fourth example, agents 16 may not be limited to allocation to a single task 22, as in the exemplary scenario 10 of FIG. 1; rather, the agent capabilities 18 of respective agents 16 may have a capacity, and the task capabilities 24 of respective tasks 22 may consume some of that capacity if the agent 16 is allocated to the task 22.

In view of these complexities and considerations, it may be advantageous to utilize an automated allocation technique that endeavors to allocate the agents 16 to the tasks 22 of the projects 20 in a manner that maximally (or at least acceptably) satisfies various preferences and interests. However, it may be difficult to devise automated techniques for large groups of resources and projects due to the large number of combinatorial options that may be available. Determining an acceptable allocation of agents 16 via exhaustive trial and error may therefore be inefficient or unacceptably protracted.

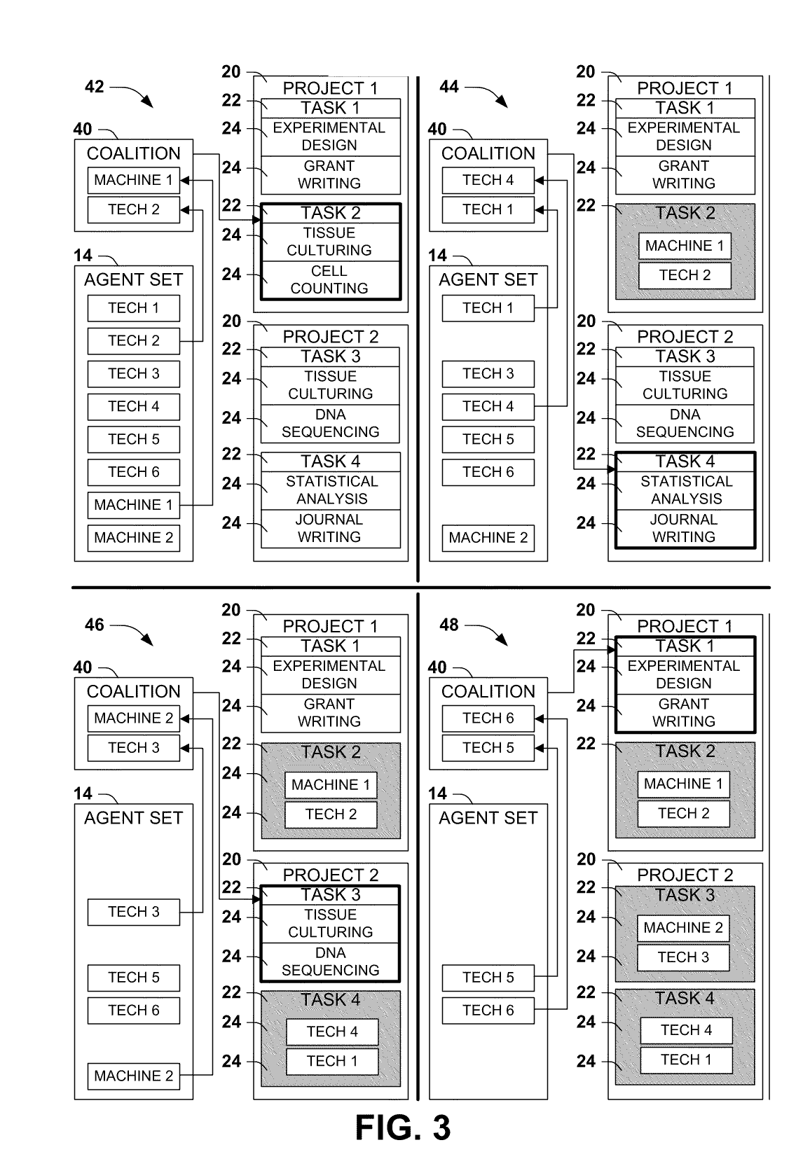

One technique for allocating agents 16 of an agent set 14 to tasks 22 in various projects 20 may involve a repeating of a selection of agents 16 to perform a task 22 that has not yet been fulfilled, until all of the tasks 22 of all of the projects 20 have been fulfilled through the allocation of a suitable set of agents 16. FIG. 3 illustrates an exemplary application of this technique, which may be performed to achieve the first allocation 30 illustrated in FIG. 2. According to this technique, the agents 16 are initially available (e.g., included in the pool of available agents 16 comprising the agent set 14), and the tasks 22 of the various projects 20 are initially unfulfilled. This technique may then be performed by selecting a coalition 40 of agents 16 to fulfill a particular task 22 until all of the tasks 22 have been fulfilled. At a first time point 42, a task 22 may be selected for fulfillment. (The task 22 may be selected arbitrarily, or by priority or value, or according to many other selection techniques.) The second task 22 is thereby selected, and from within the agent set 14, a suitable coalition 40 of agents 16 are selected to perform the task 22. In performing this selection, and according to the preferences regarding the first allocation 30 identified in FIG. 2, the manager 12 may have specified a preference to maximize the allocation of agents 16, e.g., in order to expedite the performance of the projects 20. Therefore, the first machine and the second laboratory technician are identified as having a set of agent capabilities 18 that collectively correspond to the task capabilities 24 of the second task 22. The coalition 40 may then be allocated to fulfill the task 22, and the agents 16 of the coalition 40 may be removed from the agent set 14 (or marked as unavailable, etc.) This removal reduces the number of agents 16, thereby simplifying the subsequent selection of coalitions 40 to be considered for other tasks 22. At a second time point 44, a second coalition 40, comprising the first laboratory technician and the fourth laboratory technician, who have agent capabilities 18 corresponding to the fourth task 22, may be selected; the coalition 40 may be allocated to fulfill the fourth task 22, and the agents 16 may be removed from the agent set 14. Additional allocations may be performed at a third time point 46 (allocating a coalition 40 comprising the third laboratory technician and the second machine to fulfill the third task 16) and a fourth time point 48 (allocating a coalition 40 comprising the fifth laboratory technician and the sixth laboratory technician to fulfill the first task 16) to complete the allocation.

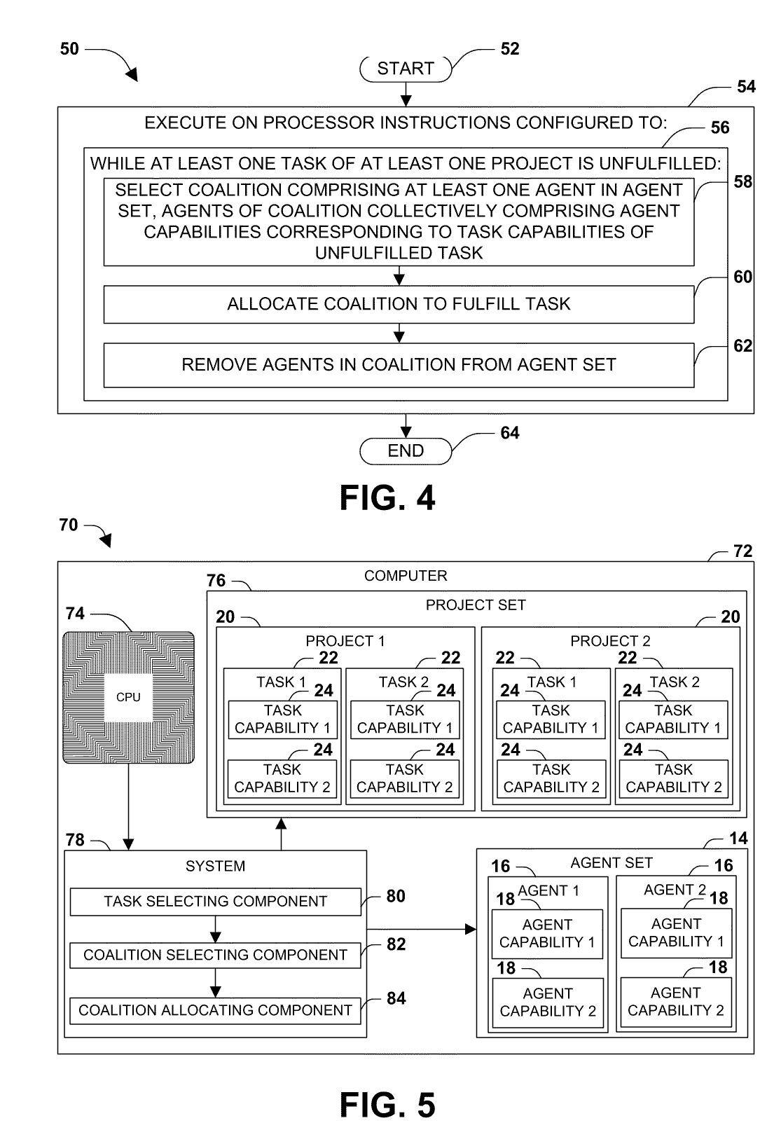

FIG. 4 presents a first embodiment of these techniques, illustrated as an exemplary method 50 of allocating an agent set 14, comprising agents 16 comprising at least one agent capability 18, to perform at least one project 20, where the projects 20 comprise at least one task 22, and where the tasks 22 comprise at least one task capability 24. The exemplary method 50 exemplary method 50 begins at 52 and involves executing 54 a set of instructions on a processor of a computer that perform the allocation according to the techniques discussed herein. More specifically, the instructions may be configured to perform a set of actions 56 repetitively while at least one task 22 of at least one project 20 remains unfulfilled. The actions 56 include selecting 58 a coalition 40, comprising at least one agent 16 in the agent set 14, where the agents 16 of the coalition 40 collectively comprise agent capabilities 16 that correspond to the task capabilities 24 of an unfulfilled task 22. The actions 56 also include allocating 60 the coalition 40 to fulfill the task 22, and removing 62 the agents 16 in the coalition 40 from the agent set 14. These actions 56 may repeat until all of the tasks 22 have been fulfilled. In this manner, the exemplary method 50 thereby allocates the agents 16 of the agent set 14 to fulfill the tasks 22, and so ends at 6.

FIG. 5 presents a second embodiment of these techniques, illustrated as an exemplary system 78 utilized within a computer 72 having a processor 74. The computer 72 has access to an agent set 14 comprising at least one agent 16, where each agent 16 has at least one agent capability 18, such as a skill that may be performed by the agent 16. The computer 72 also has access to a project set 76 comprising a set of projects 20, where each project 20 involves at least one task 22, and where each task 22 specifies at least one task capability 24 that may be used by an agent 16 while performing the task 22. The exemplary system 78 may, e.g., be implemented as a set of software instructions that are configured such that, when executed by the processor 74, cause the processor 74 to perform the techniques discussed herein. The exemplary system 78 comprises a task selecting component 80, which may be configured to select at least one unfulfilled task 22 of at least one project 20 in the project set 76. The exemplary system 78 also comprises a coalition selecting component 82, which may be configured, for the task 22 selected by the task selecting component 80, to select a coalition 40, comprising at least one agent 16 in the agent set 14, such that the agents 16 of the coalition 40 collectively comprise a set of agent capabilities 18 corresponding to the task capabilities 24 of the task 22. The exemplary system 78 also comprises an agent allocating component 84, which is configured to allocate the coalition 40 selected by the coalition selecting component 82 to fulfill the task 22 selected by the task selecting component 80, and to remove the agents 16 in the coalition 40 from the agent set 14. By operating in this manner, the exemplary system 78 thereby allocates the agents 16 of the agent set 14 according to the techniques discussed herein.

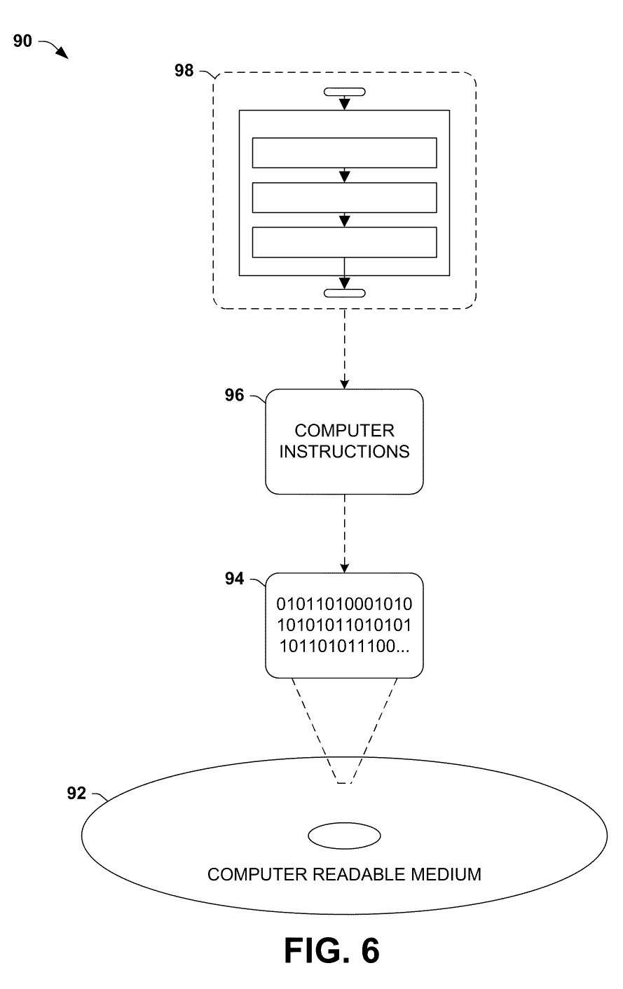

Still another embodiment involves a computer-readable medium comprising processor-executable instructions configured to apply the techniques presented herein. An exemplary computer-readable medium that may be devised in these ways is illustrated in FIG. 6, wherein the implementation 90 comprises a computer-readable medium 92 (e.g., a CD-R, DVD-R, or a platter of a hard disk drive), on which is encoded computer-readable data 94. This computer-readable data 94 in turn comprises a set of computer instructions 96 configured to operate according to the principles set forth herein. In one such embodiment, the processor-executable instructions 96 may be configured to perform a method of allocating an agent set to perform tasks of projects in a project set, such as the exemplary method 50 of FIG. 4. In another such embodiment, the processor-executable instructions 96 may be configured to implement a system for allocating an agent set to perform tasks of projects in a project set, such as the exemplary system 78 of FIG. 5. Many such computer-readable media may be devised by those of ordinary skill in the art that are configured to operate in accordance with the techniques presented herein.

The techniques discussed herein may be devised with variations in many aspects, and some variations may present additional advantages and/or reduce disadvantages with respect to other variations of these and other techniques. Moreover, some variations may be implemented in combination, and some combinations may feature additional advantages and/or reduced disadvantages through synergistic cooperation. The variations may be incorporated in various embodiments (e.g., the exemplary method 50 of FIG. 4 and the exemplary system 78 of FIG. 5) to confer individual and/or synergistic advantages upon such embodiments.

A first aspect that may vary among embodiments of these techniques relates to the types of agents 16 comprising the agent set 14, and the types of agent capabilities 18 offered by the agents and specified as task capabilities 24 by the tasks 22. As a first example, the agents 16 may comprise human agents, either as individuals, as groups of individuals, as companies, organizations, or other enterprises, etc. Alternatively or additionally, the agents 16 may comprise automated agents, such as data processing services, that are capable of providing various types of information services that may be of use in various projects 20. These types of agents 16 may be allocated and used together or separately to perform a task 22. As a second example, the agent capabilities 18 of an agent 16, and the corresponding task capabilities 24 related to the completion of a task 22, may represent many types of resources that may relate to and facilitate the completion of a task 22, such as cognitive or physical skills, possession of particular information, access to equipment, or relationships with other individuals or organizations. For example, the fourth task 22 in the exemplary scenario of FIG. 1 involves two skills (statistical analysis and journal writing), such as may be involved in the reporting of the results of a scientific experiment in a journal publication. According to the particular details of the task 22, these skills may be performed sequentially, concurrently but independently, together and perhaps synergistically, etc., and the agents 16 may interact in various ways to utilize the collective agent capabilities 18 to complete the task 22. For example, statistical analysis of experimental data might be performed before a journal article is written, in order to facilitate the deduction of experimental results on which the article may be based; or statistical charts may be conducted while a journal author prepares an article, and may be inserted to complete the draft; or a statistician and a journal author may work together to describe the statistical techniques in the journal article. Many types of agents 16 and agent capabilities 18 may be represented and allocated to various tasks 22 according to the techniques discussed herein.

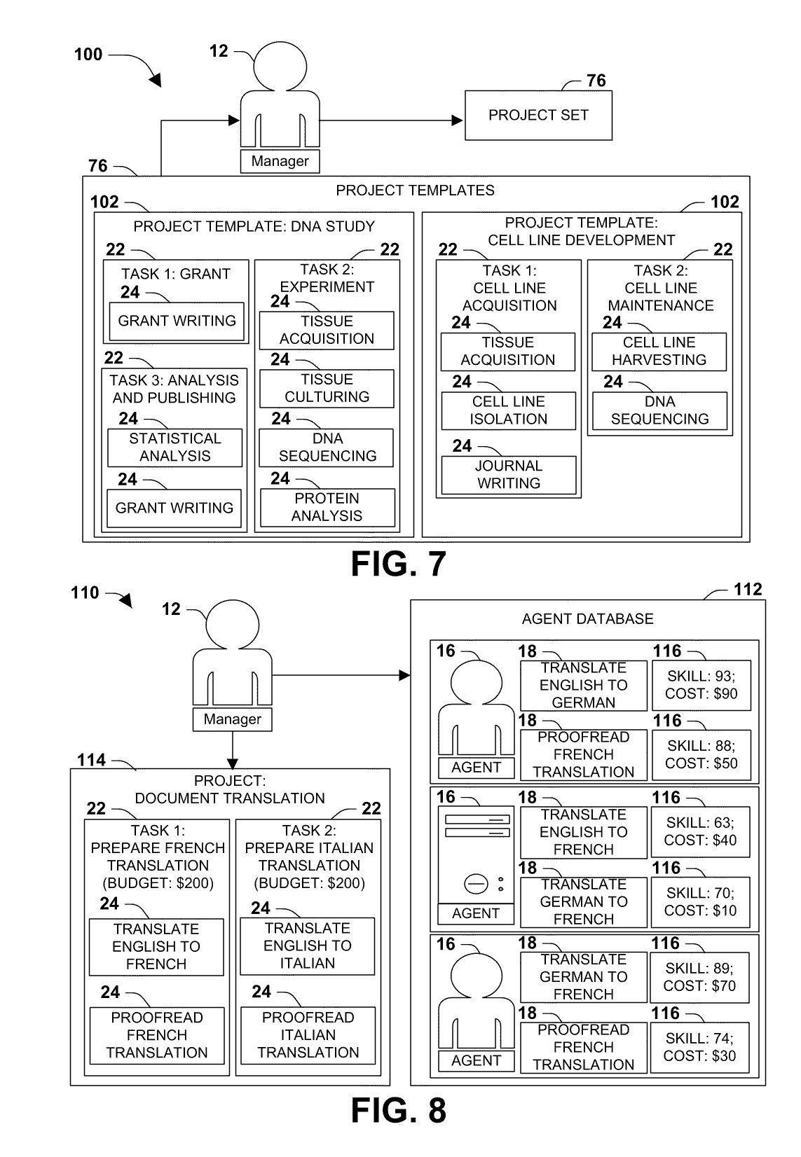

A second aspect that may vary among embodiments of these techniques relates to the creation of the project set 76 of projects 20 and tasks 2. As in the exemplary scenario 10 of FIG. 1, a manager 12 may be responsible for the performance of a set of projects 20, and may supervise a set of agents 16 (e.g., students, employees, contractors, volunteers, and/or accessible automated agents) in the completion of the projects 20. Moreover, the manager 12 may specify the projects 20 and/or tasks 22 in varying levels of detail. As a first example, a manager 12 may create a new project 20 by selecting and specifying many details about the tasks 22, such as task ordering and task capabilities. As a second example, some projects 20 may involve a predictable set of tasks 22 and/or a predictable set of task capabilities 24, and a manager 12 may simply specify the type of the project 20. FIG. 7 illustrates an illustration of this second example in an exemplary scenario 100 where a manger 12 may create a project 20 from a set of project templates 102. The manager 12 may often be involved in supervising particular types of projects, such as a DNA study involving a grant-funded acquisition and evaluation of tissue and a publication of results and the development of a cell line involving acquisition and maintenance. Project templates 102 may therefore be created to represent the tasks 22 that are typically involved in such projects 20. The manager 12 may create a new project 20 in a project set 76 based on a corresponding project template 102, and may then customize the particular details of the new project 20. As a third example, a manager 12 may not be able to determine the tasks 22 or task capabilities 24 involved in a project 20, or may have difficulty choosing between various sets of tasks 22 representing different ways of completing a project 20. An automated project evaluator may attempt to suggest a suitable set of tasks 22 and task capabilities 24, to compare and choose among various sets of tasks 22, and/or to identify new sets of tasks 22 and task capabilities 24 that may more advantageously complete a project 20. As a fourth example, if the configuration of tasks 22 for completing a first project 20 is difficult to determine, a second project 20 may be created representing the specification of tasks 22 for the first project 20. This second project 20 may resemble a Request For Proposals (RFP) invitation, wherein an agency identifies a set of intended pursuits and solicits proposals for achieving such pursuits. For example, a set of human agent 16 and automated agents 16 equipped with various project planning capabilities (e.g., selecting and ordering tasks 22 relating to a project 20; identifying the task capabilities 24 involved in such tasks 22; and evaluating different sets of tasks 22) may be allocated to a second project 20 involving the determination of a preferred set of tasks 22 for the first project 20. Those of ordinary skill in the art may devise many ways of generating the project set 76 while implementing the techniques discussed herein.

A third aspect that may vary among embodiments of these techniques relates to the generation of the agent set 14. As a first variation, an agent set 14 may already be available, such as in a company or organization where a manager 12 supervises a set of employees acting as human agents, and has access to a set of automated agents that may provide various services. As a second variation, the manager 12 may, after creating a project 20, endeavor to identify agents 16 with agent capabilities 18 suitable for performing the tasks 22 of the project 20. For example, the manager 12 might publicize the project 20 and solicit offers by agents 16 who may be capable of performing various tasks 22 of the project 20. As a third variation, an agent set 14 may be discovered, e.g., by an automated process that reviews a data set (such as a web crawler reviewing web pages on the internet, or a data mining task that evaluates resources represented in a data warehouse) to identify and add to the agent set 14 agents 16 who might be available to perform tasks 22 for future projects 20.

A fourth aspect that may vary among embodiments of these techniques relates to the scenario in which the matching may be utilized. As a first variation, these allocation techniques may be useful to a manager 12 of a known set of agents 16, such as in the exemplary scenario 10 of FIG. 1. As a second variation, a matching service may be devised that matches agents 16 with projects 20 according to the tasks 22 that may be performed according to the agent capabilities 18 of the agents 16. For example, the matching service, such as a website, may comprise an agent database, and agents 16 may be permitted to register with the agent database and to assert a set of agent capabilities 18 representing the skills of the agent 16 that may be of use in projects. The matching service may also comprise a project set 76, and managers 12 may be permitted to create projects 20 in the project set 76. The matching service may then automatically perform the matching in order to identify and allocate a coalition 40 of agents 16 to perform the tasks 22 of a project, may notify the manager 12 and the allocated agents 16 of the allocation, and may coordinate the performance of the project 20.

FIG. 8 presents, within an exemplary scenario 110, an implementation of this variation comprising an exemplary agent database 112 with which agents 16 may register in order to provide language translation services. The agent set 112 may include both human agents and automated agents, such as an automated document translation engine that may be used in various translation projects. Additionally, the agents 16 may offer particular agent capabilities 18 representing such services as translating from a first language to a second language or proofreading a document in a particular language. Moreover, the agent capabilities 18 of various agents 16 may indicate a capability proficiency, such as the comparative quality of the service provided, and/or a cost of such a service that may be charged to the project 20 for providing the service. Additionally, a manager 12 may create a document translation project 114, involving the translation of a source document in English to a translated French document (as a first task 22) and to a translated Italian document (as a second task 23.) Moreover, the manager 12 may specify a budget for the respective tasks 114.

Once the agent set 112 and the project set 76 are provided to a matching service (such as in the exemplary scenario 110 of FIG. 8), many techniques may be applied to perform the matching. As a first example, the matching service (such as a website) may search for qualifying agents 16 who possess agent capabilities 18 corresponding to the task capabilities 24 of the tasks 22 of the project 20, and may present such agents 16 to the manager. The manager 12 may then select the agents 16 and may arrange to have the project 20 performed thereby. Additionally, if multiple agents 16 are available and capable of contributing relevant agent capabilities 18 to a task 22, the manager 12 may be permitted to choose agents 16 for the task 22, such as according to cost and/or translation quality. As a second example, respective agents 16 may be offered a set of projects 20 in which they may be capable of participating in at least one task 22 having a task capability 24 corresponding to the agent capabilities 18 of the agent 16. The agent 16 may then be permitted to accept or decline various offers, and the matching service may include the agent 16 in a coalition 40 upon receiving an acceptance by the agent 16. As a third example, an auction model may be devised to match agents 16 with tasks 22 of a project 20. When a project 20 is received, a set of coalitions 40 may be identified, and the coalitions 40 may competitively bid (e.g., by cost or timeliness) in order to be matched with various tasks 22 of the project 20, and/or agents 16 may competitively bid for inclusion in a particular coalition 40. Moreover, this auction model may be hierarchically structured; e.g., an agent 16 or coalition 40 that wishes to place a competitive bid for a task 22 of a project 20 may subcontract part or all of the task 22 by creating a subproject and soliciting bids from other agents 16.

However, in a decentralized model such as an auction, complications may arise due to the comparatively loose (and perhaps even unidirectionally or mutually anonymous) relationships among a manager 12 and the agents 16 allocated to the project 20 of the manager 12. For example, a manager 12 may be hesitant to rely on a loosely aggregated set of agents 16 to perform a large or significant project, where one poorly performed task 22 or poorly performing agent 16 may significantly impair or jeopardize the project 20. Therefore, additional variations of the auction model may be included to improve the reliability of the performance of the tasks 22 by the agents 16. As a first example, when an agent 16 (particularly a human agent) submits a request to be added to an agent database 112 and asserts an agent capability 18, a capability test may be generated and provided to the agent 16 to verify the asserted agent capability 18. For example, if an agent 16 claims a capability of translating a document from English to French, a previously translated English document may be provided to the agent 16, and the resulting French translation provided by the agent 16 may be evaluated (e.g., by comparison with a French document from the previous translation that was rated of high quality.) If the agent 16 passes the capability test, the agent 16 may be added to the agent database 112. Moreover, the proficiency of the agent 16 may be evaluated and rated during the testing. Alternatively or additionally, the cost of the agent 16 in performing the agent capability 18 may be adjusted according to the detected capability proficiency of the agent capability 18 (e.g., higher charges may be associated with the services of agents 16 having a higher capability proficiency in a particular agent capability 18), and a feedback system may be incorporated, where the agent capabilities 18 of agents 16 are rated by managers 12 for completed tasks 22. These techniques may promote the development of a high-quality and reliable agent database 112 that managers 12 may more highly trust. As a second example, the reliability of a project may be improved by redundantly allocating agents 16 to a coalition 40, e.g., where at least two agents 16 in a coalition have an agent capability 18 corresponding to a task capability 24 of a task 22. The agents 16 may therefore work in tandem to produce a higher-quality performance of the task 22, may supervise each other's work, and/or each may serve as a backup in case another of the redundantly allocated agents 16 fails to complete the task 22.

Additional variations of this fourth aspect may relate to services that, after allocating agents 16 to tasks 22 of a project 20, also endeavor to secure the performance of the tasks 22 by the agents 16 after the allocation. As a third variation, after identifying sets of coalitions 40 of agents 16 to be allocated to various tasks 22, an embodiment of these techniques may commit the coalitions 40 to perform the respective tasks 22. For example, a matching service may notify the agents 16 of respective coalitions 40 of the allocation (e.g., that a competitive bid submitted by the agent 16 or coalition 40 has succeeded), and may obligate the agents 16 to perform the tasks 22. The matching service may also facilitate the agents 16 in performing the tasks 22, such as by monitoring the progress of the agents 16 and reporting such progress to the manager 12 of the project 20. As a second example, an embodiment may track the performance of the tasks 22 and may reward agents 16 accordingly, e.g., by billing a manager 12 upon detecting the completion of a task 22 and allocating the payment received from the manager 12 to the agents 16.

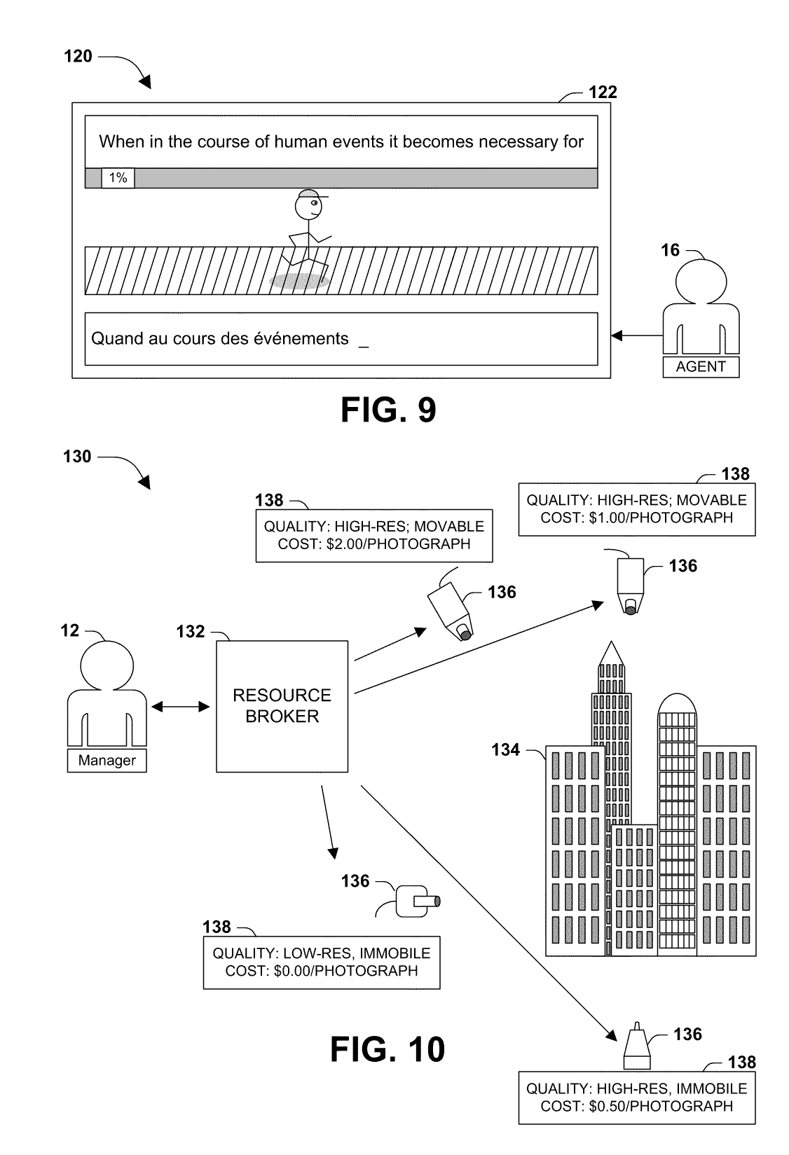

As a third example, an embodiment may assist an agent 16 (particularly a human agent 16) in performing a task 22 by formulating the task 22 as a game. FIG. 9 illustrates one such exemplary scenario 120 wherein an embodiment may facilitate an agent 16 in performing a task 22 (e.g., using an English-to-French translation agent capability to perform an English-to-French translation of an English document) by presenting the task 22 to the agent 16 as a game 122. The game 122 may involve a depiction of an individual running along a course in a race, where the running is performed while the agent 16 by typing a French translation of the English document. The game 122 may therefore present the progress of the agent 16 through the task 22 and may visually associate the rate of the agent 16 performing the task 22 as the pace of the running individual in the game 122. Moreover, if the embodiment detects translation errors (e.g., portions of the translation that are identified as having a low confidence of matching the corresponding portion of the English document), the individual in the game 122 may be depicted to trip or slow down, thereby prompting the agent 16 to correct the translation error. The agent 16 may also be encouraged to provide a high-quality performance of the task 22 by rewarding the agent 16 within the game 122, e.g., by displaying a high score or by allowing the agent 16 to continue playing. Moreover, the game 122 may be presented to several or all of the agents 16 within a coalition 40, e.g., as a relay race or a pack of cooperating or competing runners who endeavor to complete the race together. The presentation of the task 22 to the agent 16 as a game (such as the game 122 presented in FIG. 9, or any other game) may therefore facilitate the agent 16 in performing the task 22. However, those of ordinary skill in the art may devise many such scenarios for matching agents 12 with tasks 22 of various projects 20, and for committing coalitions 40 to the tasks 22, while implementing the techniques discussed herein.

Still other variations of this fourth aspect involve broad, more complex, and/or more capable embodiments of problem-solving systems (comprising both human and automated agents) wherein the techniques discussed herein may be utilized. As a fourth variation, many types of agents 16, having many forms of agent capabilities 18, may be selected and confederated into coalitions to perform a task 22. In addition to comprising humans (or other biological organisms) or automated processes, agents 16 involved in fulfilling a task 22 may represent many agent types. As a first example, and as illustrated in FIG. 1, agents 16 may represent a skill agent, human individuals or machines that have one or more agent capabilities 18 representing a particular skill. As a second example, a sensor agent may have an agent capability 18 representing a sensory output, such as a camera, a metal or X-ray detector, a telescope, or a taste or smell sensory perception of a human agent. As a third example, an effector agent may have an agent capability 18 representing a transformative effect, such as a capability of achieving a particular type of physical transformation that may be useful in fulfilling a physical task. As a fourth example, a resource agent may have an agent capability 18 representing an access to a resource, such as an owner of a piece of equipment, an amount of money that may be allocated to the task 22, or a social contact with another human with whom the task 22 may involve interacting. As a fifth example, a task evaluation agent may have an agent capability 18 representing a logical evaluation of a task 22, such as an expert in a particular area who may be consulted to identify the tasks 22 involved in a project 20 or the types of agents 16 who may form an effective coalition 40 for fulfilling the task 22.

These and other agent types may be identified and selected to form a coalition 40 to perform a particular task 22 using many such types of agent capabilities 18. Moreover, the scope of tasks that may be performed by agents 16 having a diverse set of agent capabilities 18 may be very broad. Such applications may include, e.g., mapping a location using a distributed set of mapping resources; creating a model of a scene by capturing images from a variety of cameras; building a structure, such as a house, using a variety of construction agents and resources; planting trees; cooking a large meal; conducting acoustic analyses using an acoustic array; translating documents from one language to several other languages; building and maintaining a large software architecture using a distributed set of development resources; large-scale public works of art, utilizing many distributed groups of individuals with various talents and resources; etc. In general, many tasks 22 that are amenable to crowdsourcing, distributed or loosely collaborative performance, or resource sharing may be achieved through applications of the techniques discussed herein.

FIG. 10 presents an exemplary scenario 130 featuring a set of agents 16 that may be selected to fulfill a task 22. However, the task 22 presented in this exemplary scenario 130 does not involve skills, but rather a set of sensory outputs generated by various sensor agents. A manager 12 of a media project may endeavor to generate a media presentation of a city 134, such as a skyline or a three-dimensional model. The manager 12 may therefore seek a set of photographs of the city 134, such as different buildings photographed by cameras positioned at different locations, different angles, different times of day or seasons, etc. The media project may call for a large number of such photographs or locations, or may seek photographs from a wide variety of cameras, and the manager 12 may not have the resources to acquire such cameras. Instead, a resource broker 132 may be configured to identify available sensor agents 136 representing different cameras that may be positioned within the city 134 (e.g., webcameras managed by various operators), and may be able to broker an acquisition of photographs from such sensor agents 136 on behalf of clients. For example, the manager 12 may consult the resource broker 132 to specify a number and condition of the types of photographs sought, and the resource broker 132 may coordinate the acquisition of photographs from the various sensor agents 136. Moreover, respective sensor agents 138 may specify various agent properties, such as the location of the camera, the quality of photographs that may be produced, whether the camera is mobile (having an adjustable angle, position, etc.) or immobile, etc., and a cost to be charged to the manager 12 in exchange for acquiring the photograph. The resource broker 132 may therefore select a set of sensor agents 136 satisfying the budget and conditions of the manager 12, and may coordinate the payment of the manager 12 to the owners of the respective sensor agents 138.

FIG. 10 presents another exemplary scenario 140 featuring a set of agents 22 to be selected for a physical task 142 involving a relocation of a mound of soil in a construction project. A manager 12 of the construction project may seek a solution to fulfill the physical task 142, but may have neither the skill to identify the various components of the physical task 142 nor the agents 22 or resources involved. The manager 12 may consult a resource broker 132 that tracks a set of agents 22 capable of performing various construction-related tasks. In particular, the resource broker 132 may track a set of effector agents 144, each of which may be capable of performing a transformative effect on the physical task 142. For example, the resource broker 132 may generate for the manager 12 a coalition 40 of effector agents 144 including an owner of a backhoe having an effector agent capability 146 representing a digging effect in order to dig and loosen the mound of soil; an owner of a bulldozer having an effector agent capability 146 representing a pushing effect that may be utilized to push the loosened mound of soil to another location on the site; and a shovel team with a truck having an effector agent capability 146 representing a transportation of quantities of soil away from the construction site. These effector agents 144 may be selected by the resource broker 132 to form a coalition capable of performing the physical task 142 on behalf of the manager 12. The resource broker 132 may also handle the charging of the fees of the effector agents 144 to the manager 12 and the allocation of the payment among the effector agents 144. Those of ordinary skill in the art may devise many agent types, having many types of agent capabilities, and which may be confederated in many ways in order to perform a wide variety of tasks and projects according to the techniques discussed herein.

FIG. 12 presents yet another exemplary scenario 150 wherein the techniques discussed herein may be applied to allocate agents 22 to fulfill the tasks 22 of a project. In this exemplary scenario 150, an exemplary system 152 is provided that may be configured to evaluate a task 22 received from a manager 12, select and allocate agents and resources, and accomplish the task 22 for the manager 12. The exemplary system 152 may receive the task 22 from the manager in an informal manner, e.g., as a natural language query or narrative. The exemplary system 152 may therefore feature a task interpreting component 154, e.g., a natural language parser that may evaluate the query or narrative describing the task 22, and may generate a formal task specification 164. The exemplary system 152 may also feature a task decomposition component 156, which may be configure to logically evaluate the task specification 164, and may identify a set of processes involved in performing the task 22. In particular, the task decomposition component 156 may identify a subtask structure 166, e.g., a set of subtasks that maybe connected in series and/or in parallel to form a comprehensive process whereby the task 22 may be completed. The exemplary system 152 may also feature a task planning component 158, which may endeavor to identify the manner of completing respective subtasks 172 through the allocation of agents 22 and resources. For example, the task planning component 158 may invoke the task selecting component 80, the coalition selecting component 82, and the agent allocation component 84 of the exemplary system 78 of FIG. 5 in order to allocate a coalition 40 to perform respective subtasks 74 of the subtask structure 166, and to produce a coalition allocation 168 for respective subtasks 172. The exemplary system 152 may also feature a task coordination component 160, which may utilize the coalition allocations 168 for respective subtasks 172 to coordinate the performance of respective subtasks 172 by various agents 22 and coalitions 40, and when a coalition 40 fulfills a subtask 172, may receive from the coalition 40 one or more subtask results 170 (e.g., a notification of fulfillment, a solution to a problem involved in the subtask, or a resource produced by the subtask 172, such as a translated text in a language translation subtask.) Finally, the exemplary system 152 may comprise a task composition component 162, which may be configured to compile the subtask results 170 into a task result 174, which may be provided to the manager 12 in order to fulfill the task 22.

In view of this exemplary scenario 150, some interesting variations may be achieved. First, the components of the exemplary system 152 may be performed by various agents 22 and coalitions 40; e.g., a coalition 40 may be allocated to serve as the task interpreting component 154 in order to produce the task formal specification 164, or as the task decomposition component 156 in order to identify a suitable subtask structure 166 of a task 22. A resource broker 132 may therefore track various types of task evaluation agents who may be adept at serving in coalitions allocated to the various components of the exemplary system 152; e.g., a construction industry expert who is adept at evaluating construction projects and producing task formal specifications 164 may be identified by a resource broker 132 as suitable for serving as the task interpreting component 154 for construction-related tasks. An auction or market model may be developed around to implement the exemplary system 152 among sets of resource brokers 132 who may identify suitable human and/or automated agents 22 capable of serving in the capacities of the exemplary system 152 for various tasks 22 on behalf of various managers 12. As a second example, one or more exemplary systems 152 may be recursively or cooperatively invoked to evaluate a nested hierarchy of subtasks 172; e.g., a particular subtask 172 identified as part of a subtask structure 166 of a task 22 may be difficult to evaluate as a single subtask 172, and may therefore be fed back into the exemplary system 152 (or another such system) in order to evaluate, allocate resources for, and fulfill the subtask 172. Those of ordinary skill in the art may devise many uses of the exemplary system 152 according to the techniques discussed herein.

A fifth aspect that may vary among embodiments of these techniques relates to the selection of coalitions 40 of agents 16 for respective tasks 22 in view of differing preferences of the manager 12. Where several sets of coalitions 40 of agents 16 may be allocated to a particular set of tasks 22 and projects 20, it may be preferable to select an allocation that desirably improves or maximizes positive properties of the allocation, and/or desirably reduces or minimizes adverse properties of the allocation. Moreover, the preferential allocation may be multifactorial; e.g., many preferences may be considered and factored into the automated allocation of coalitions 40 to the tasks 22 of the projects 20.

As a first variation, various agents 16 may perform different agent capabilities 18 with different levels of capability proficiency. These capability proficiencies may be measured in many ways, such as by reviewing the credentials of the agent 16, by reviewing previously completed tasks 22 of the agent 16, or by testing the agent 16 with a generated test and scoring the results. Alternatively, the capability proficiency of an agent capability 18 of an agent 16 may be evaluated with a learning function, such as a neural network or a Bayesian classifier. For example, the learning function may be trained to identify the capability proficiency of an agent capability 18 in a proficiency training set, e.g., a set of documents in a first language and translated documents in a second language, along with a proficiency score indicative of the capability proficiency of the translator. Once trained, this learning function may be applied to the agent capability 18 of an agent 16 to predict or classify the capability proficiency thereof. If such capability proficiencies may be determined or measured, it may be desirable to select and allocate coalitions 40 that maximize the capability proficiencies of the agent capabilities 18 of the agents 16 corresponding with the task capabilities 24 of the tasks 22 to which the respective coalitions 40 are allocated, in order to promote a high quality of work resulting from the performance of the tasks 22. As a first example, for any unfulfilled task, the coalition 40 of agents 16 may be allocated that produces the highest sum or product of capability proficiencies of the agent proficiencies 18 of the agents 16 corresponding to the task capabilities 24 of the unfulfilled task 22. As a second example, at any stage of selection, coalitions 40 of agents 16 having high agent capabilities 18 may be prepared and compared with the task capabilities 24 of the unfulfilled tasks 22, and upon finding a match of a coalition 40 to an unfulfilled task 22, the coalition 40 may be allocated to the unfulfilled task 22. This example may promote an allocation of respective agents 16 according to their highly proficient agent capabilities 18. In a similar manner, qualities other than proficiency of an agent 16 or an agent capability 18 may be evaluated (such as by an accordingly trained learning function) and accordingly preferred or disfavored in the selection of agents 18 for coalitions 40, such as reliability, timeliness, or availability.

As a second variation, various agents 16 may offer agent capabilities 18 with associated capability costs. As a first example, a manager 12 of agents 16 serving as employees may have access to the salaries of the respective agents 16, and may be able to calculate the cost in salary of selecting a particular agent 16 to perform a particular task 22, according to a predicted duration whereby the agent 16 uses the agent capability 18 while performing the task 22. As a second example, agents 16 participating in a matching service may offer respective agent capabilities 18 with stated capability costs, such as a per-hour or per-task price, or may submit a competitive bid stating a price for utilizing a particular agent capability 18 for a particular task 22. In these and other scenarios, it may be desirable to select and allocate coalitions 40 to reduce the capability costs of the agent capabilities 18 utilized in the tasks 22 and projects 20. The cost reduction may, e.g., be a minimization, or may comprise a cost threshold (such as a budget), wherein any set of allocated coalitions 40 to respective tasks 22 is acceptable if the capability costs of the agent capabilities 18 corresponding to the task capabilities 24 of the tasks 22 yield a sum below the cost threshold or within the budget. Alternatively, the capability costs may be factored together with capability proficiencies of various agent capabilities 18, such that a desirably proficiency/cost ratio of the selected agent capabilities 18 may be achieved. This reduction or minimization may be implemented in the selection and allocation of coalitions 40 and agents 16 in many ways. As a first example, for any unfulfilled task, the coalition 40 of agents 16 may be allocated that produces a desirably or minimally low total capability cost of the agent proficiencies 18 (or a comparably high proficiency/cost ratio) of the agents 16 corresponding to the task capabilities 24 of the unfulfilled task 22. As a second example, coalitions 40 of agents 16 having a low total capability cost (or a comparably high proficiency/cost ratio) may be prepared and compared with the task capabilities 24 of the unfulfilled tasks 22, and allocations of coalitions 40 may be selected accordingly.

As a fourth variation, it may be desirable to achieve a comparatively high or low number of agents 16 comprising the coalitions 40 allocated to the tasks 22 and projects 20 of the project set 76. As a first example, it may be desirable to promote or maximize the number of agents 16 allocated to the tasks 22, e.g., by selecting coalitions 40 where respective agents 16 are contributing only one or a few agent capabilities 18 to the task 22. This may be desirable, e.g., for usefully employing all of the agents in a particular agent set 14 such as a group of employees, and/or for achieving a quicker completion of tasks 22 by promoting concurrent efforts by different agents 16. Therefore, allocations of coalitions 40 may be preferentially selected and matched with tasks 22 where such coalitions 40 feature a higher number of agents 16. Conversely, it may be desirable to reduce the sizes of the coalitions 40, e.g., in order to conserve the allocation of agents 16 and to free agents 16 for allocation to other projects 20, or to reduce the unreliability, unpredictability, or management burden of a larger coalition due to the large number of agents 16 involved. This may be achieved by preferentially selecting and matching tasks 22 with coalitions 40 that feature a comparatively lower number of agents 16.

As a fifth variation, it may be desirable to achieve a comparatively high efficiency of agent capabilities 18 allocated to the tasks 22 and projects 20 of the project set 76. For example, if an agent 16 may only be allocated to one task 22 at a time, agents 16 may be preferentially selected for a coalition 40 that have fewer unused agent capabilities 18. This may be advantageous, e.g., for preserving the pool of unallocated agent capabilities 18 among the unallocated agents 16 in order to permit a wider range of additional projects 20 and tasks 22 to be accepted and performed. This may be achieved, e.g., by selecting for an unfulfilled task 22 a minimal coalition 40, wherein the agents 16 of the coalition 40 comprise a minimum of agent capabilities 18 that do not correspond to the task capabilities 24 of the task 22. As one example, agents 16 with fewer agent capabilities 18 (e.g., only one agent capability 18) may be identified, along with any unfulfilled tasks 22 utilizing the agent capabilities 18 of the agent 16. A coalition 40 may then be selected and allocated to the task 22 that includes this agent 16, thereby promoting both the inclusion of agents 16 that might be difficult to allocate to tasks 22 due to the small set of agent capabilities 18, and for reducing the unused agent capabilities 18 of the agents 16 in the coalition 40. Those of ordinary skill in the art may identify many aspects of the allocation of coalitions 40 to tasks 22 that may be preferentially promoted or reduced, and of achieving such preferential allocations, while implementing the techniques discussed herein.

Additional variations of this fifth aspect relate to additional sophistication or nuance in the modeling of agent capabilities 118, tasks 22, etc., and the allocation of coalitions 40 to tasks 22 in view of these additions. As a first example, in contrast with the exemplary scenario 10 of FIG. 1, it may be permissible to allocate an agent 16 to more than one task 22, as long as the agent 16 only uses each agent capability 18 to correspond to one task capability 24 of one task 22. For example, an agent 16 may be permitted to allocate a first agent capability 18 to a task capability 24 of a first task 22 and a second agent capability 18 to a task capability 24 of a second task 22, such as by allowing the agent 16 to participate in several coalitions 40 (but not allowing the agent 16 to allocate the same agent capability 18 to multiple tasks 22.) This may be achieved, e.g., by limiting the selection of coalitions 40 to sets of agents 16 having only unallocated agent capabilities 18 corresponding to the task capabilities 24 of a task 22, and by removing an agent 16 from the agent set 14 only when all of the task capabilities 18 of the agent 16 are allocated. It may be appreciated that the relaxation of this restriction may significantly increase the number of possible combinations of agents 16 in a coalition 40 for a particular task 22, resulting in a higher computational burden to perform the allocation. This burden may be reduced, e.g., by limiting on the number of coalitions 40 in which an agent 16 may participate.

As a second example, the allocation of an agent capability 18 corresponding to a task capability 24 of a task 22 may not fully consume the agent capability 18, and vice versa. Previous examples (such as the exemplary scenario 10 of FIG. 1) are limited by the presumption that an allocation of an agent capability 18 of an agent 16 corresponding to a task capability 24 of a task 22 fully satisfies that task capability 24 and fully consumes the agent capability 18. However, this limitation may be relaxed, and the agent capability 18 of an agent 16 may have a capability capacity, such as an amount of the agent capability 18 that the agent 16 may be able to commit to one or more task capabilities 24 of a task 22. Conversely, a task capability 24 of a task 22 may have a capability consumption specifying an amount of the agent capability 18 to be allocated in order to fulfill the task capability 24. For example, within a particular time frame for completing a project 20, an agent 16 may have a limited number of hours to commit to tasks 22 of the project 20. Additionally, a task 22 of the project 20 may have a task capability 24 specifying a number of hours of the corresponding agent capability 18 that are likely to fulfill the task capability 24 of the task 22. While the relaxation of this limitation may further complicate the allocation of coalitions 40 to tasks 22, this model may more realistically represent resource availability, utilization, and consumption in many real-world scenarios.

The allocation of coalitions 40 to tasks 22 may be adjusted in view of specified capability capacities of agent capabilities 18 and capability consumptions of task capabilities 24. As a first example, a coalition 40 may be selected for an unfulfilled task 22 only if the collective capability capacities of the agent capabilities 18 at least satisfy the corresponding capability consumptions specified for various task capabilities 24. As a second example, when a coalition 40 is allocated to a task 22, the capability capacities of the agent capabilities 18 of the agents 16 of the coalition 40 may be reduced by the capability consumption 184 of the corresponding task capabilities 24 of the task 22. If two or more agents 16 contribute the same agent capability 18 corresponding to a task capability 24, the reduction of the capability consumption of the task capability 24 may be allocated across the capability capacities of the agents 16 in various ways. As a third example, an agent 16 may be removed from the agent set 14 only when no capability capacity remains in any of the agent capabilities 18 of the agent 16.

FIG. 10 illustrates an exemplary scenario 180 where various agent capabilities 18 specify a capability capacity 182 representing the amount of the capability capacity 182 may be available for allocation to one or more tasks 22. Similarly, the task capacities 24 of the tasks 22 specify a capability consumption 184 representing the amount of the capability capacity 182 utilized in order to fulfill the task capability 24. An embodiment of these techniques may allocate the agents 16 in view of the specified capability capacities 182 and capability consumptions 184. As a first example, the first agent 16 may have enough capability capacity 182 of the first agent capability 18 (i.e., translating English to French) to satisfy both the first task capability 24 of the first task 22 and the first task capability 24 of the second task 22. Accordingly, the first agent 16 may be allocated to both a first coalition 40 allocated to fulfill the first task 22 and a second coalition 40 allocated to fulfill the second task 22. Conversely, the second task capability 24 of the first task 22 (i.e., proofreading a French translation) by consuming the capacities of the corresponding agent capability 18 of both the first agent 16 and the second agent 16. This allocation may be distributed in many ways; e.g., the capability consumption 184 may be evenly allocated, or may be partly or wholly shifted to a preferred agent 16. After the allocation illustrated in the exemplary scenario 180 of FIG. 10, the agent capabilities 18 of the first agent 16 are fully allocated, and so the first agent 16 may be removed from the agent set 14.

As a third example, the tasks 22 comprising a project 20 may have a serial order of performance, such that a following agent capability 18 may only be utilized after a preceding agent capability 18 is utilized. As one such example, in the first task 22 of FIG. 8, the task capability 24 involving the proofreading of the French translation may only be performed after the task capability 24 involving the translation of the English document into French. This addition may complicate the allocation, because if a first agent 16 is allocated to a coalition 40 in order to utilize a preceding agent capability 18 for a task 22, and a second agent 16 is allocated to the coalition 40 in order to utilize a following agent capability 18 for the same task 22, the second agent 16 may be idle until the utilization of the preceding agent capability 18 is complete, thereby creating a source of inefficiency. This inefficiency may be avoided in many ways, e.g., by preferentially selecting a single agent 16 with both task agent capabilities 18, both of which may be utilized on the task 22. Alternatively, the performance of the agent capabilities 18 may be scheduled, such that, while the first agent 16 is performing the preceding agent capability 18 in the coalition 40, the second agent 16 may participate in another coalition 40 utilizing a different agent capability 18.

Still other variations of this fifth aspect relate to the expansion of the allocation to consider other options for performing a task 22 through an allocation of agent capabilities 18. In the exemplary scenario 110 of FIG. 8, the first task 22 involves a preparation of a French language translation of an English language document, involving a first task capability 24 of translating the document from English to French and a second task capability 24 of proofreading the French translation. This may be directly achieved, such as by applying the exemplary method 50 of FIG. 4, by selecting a coalition 40 comprising the second agent 16 (the automated agent) utilizing the “translate English to French” agent capability 18 and either the first agent 16 or the third agent 16 (either of the human agents) utilizing the “proofread French translation” agent capability 18. Either coalition 40 may be allocated to the task 22 to produce the French language translation of the English language document. However, either allocation has a potential disadvantage arising from the comparatively poor capability proficiency 116 of the “translate English to French” agent capability 18 of the second agent 16. While this agent 16 may perform this agent capability 18 cheaply, the resulting quality is poor. Unfortunately, not other agents 16 in the agent database 112 comprise the “translate English to French” agent capability 18.

However, if an embodiment of these techniques is permitted to consider alternatives in the performance of the task 22, it may identify a coalition 40 that may perform the task 22 with improved quality by translating through a German language text. The first agent 16 may be selected to perform the “translate English to German” agent capability 18 with a comparatively high capability proficiency 116. The third agent 16 may then be selected to perform the “translate German to French” agent capability 18 with a similarly high capability proficiency 116. Finally, either the first agent 16 or the third agent 16 may perform the “proofread French translation” agent capability 18 to complete the first task 22. This allocation may be more indirect, and might introduce both slightly less reliability (due to the additional agent capability 18 to be performed), along with an additional loss of quality due to the intermediate translation. However, the resulting quality of the translation may still be higher, due to the significantly higher capability proficiencies 116 of the first user 16 and the third user 16 in contrast with the comparatively low capability proficiency 116 of the machine agent 16.

In order to permit an embodiment of these techniques to identify alternative ways of performing a task 22, it may be advantageous to consider each agent capability 18 as a transition between two task states. In the exemplary scenario of FIG. 8, the first task 22 of the document translation project 114 begins with a task start state (an English language document) and ends with a task end state (a finished French language document.) However, the task capabilities 24 specified for the first task 22 represent only one possible set of transitions from the task start state to the task end state. The agent capability 18 representing “translate English to German” may be regarded as a transition from an English language document to a German language translated document; the “translate German to French” agent capability 18 as a transition from a German language translated document to a French language translated document; and the “proofread French translation” agent capability 18 as a transition from a French language translated document to a finished French document. Based on this representation of the agent capabilities 18, an automated allocation system may identify these three agent capabilities 18 as comprising an alternative sequence of agent capabilities 18 leading from the task start state to the task end state. Moreover, the utility of this alternative sequence (e.g., the cost and the quality of the resulting work) may be computed, and if higher than the utility of other such sequences (including the sequence of task capabilities 24 specified in the task 22), the alternative sequence may be preferentially selected for the performance of the task 22.

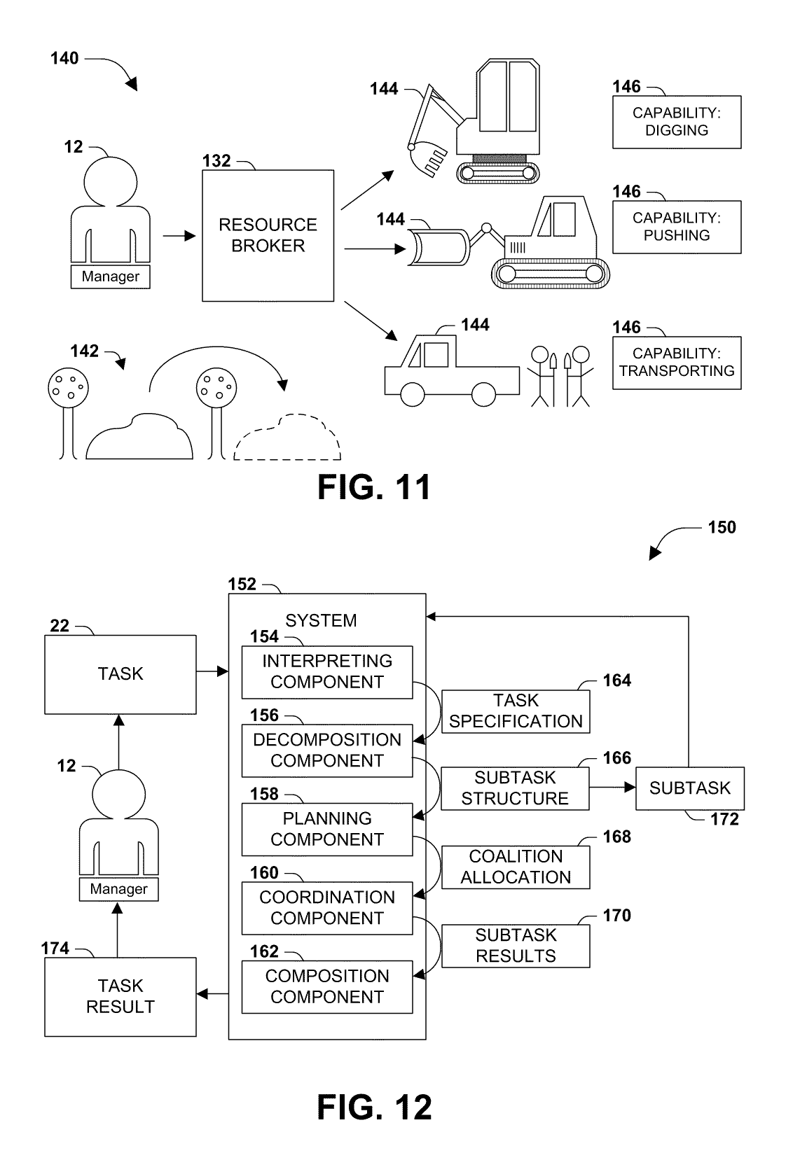

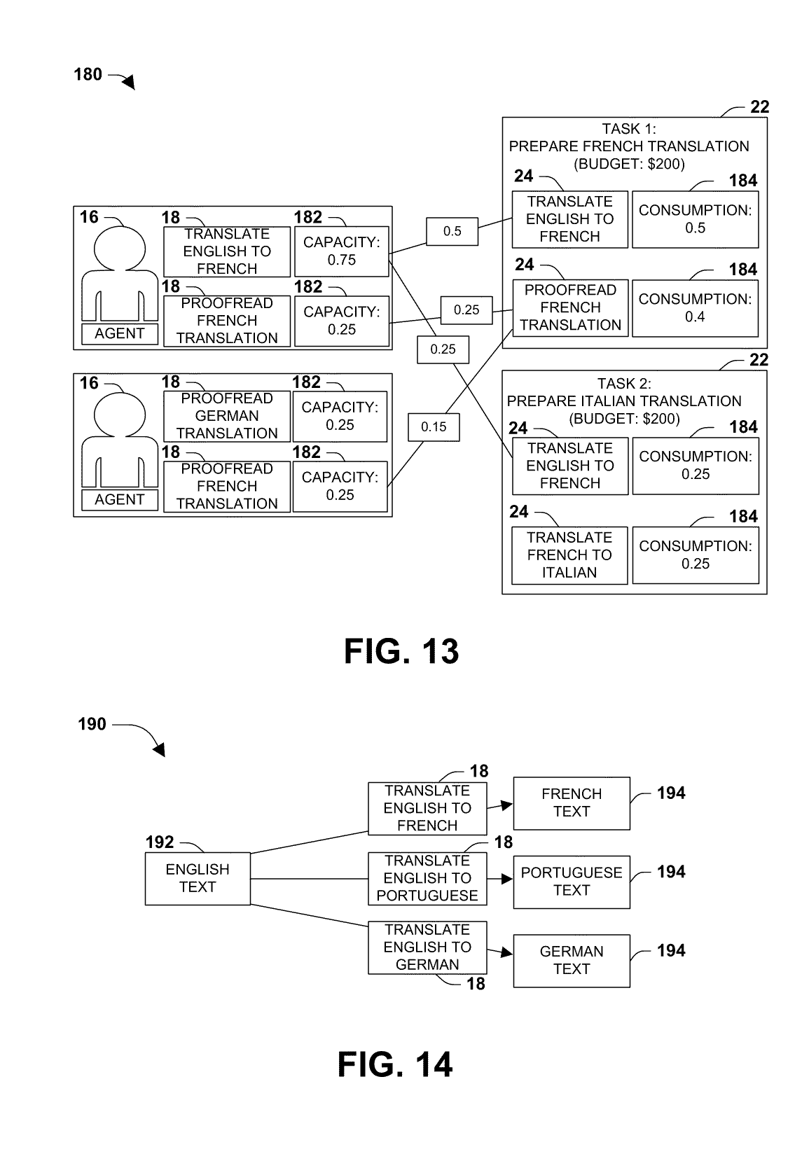

FIGS. 11-12 together illustrate some advantages of this technique. FIG. 14 illustrates an exemplary scenario 190 of a translation project 20 beginning with an English language document 192 and ending with translations into other languages (each translation representing a task 22 of the project 20.) The exemplary scenario 190 featuring a set of task states, including a task start state 192 representing the English language document 192 and ending at various task end states 194. The respective tasks 22 may be performed through a single task capability 24, e.g., a first task capability 18 representing a translation of the English language document to a French text 194 (as a first task end state); a second task capability 18 representing a translation of the English language document to a Portuguese text 194 (as a second task end state); and a third task capability 18 representing a translation of the English language document to a German text 194 (as a third task end state.) However, an examination of an agent set 14 (e.g., the agent database 112 of FIG. 8) may reveal that agents 16 having these agent capabilities 18 are unavailable, too expensive, or produce translations of insufficient quality. Alternatively, such agents 16 may be available and satisfactory, but an improved solution may be identified by considering alternatives.

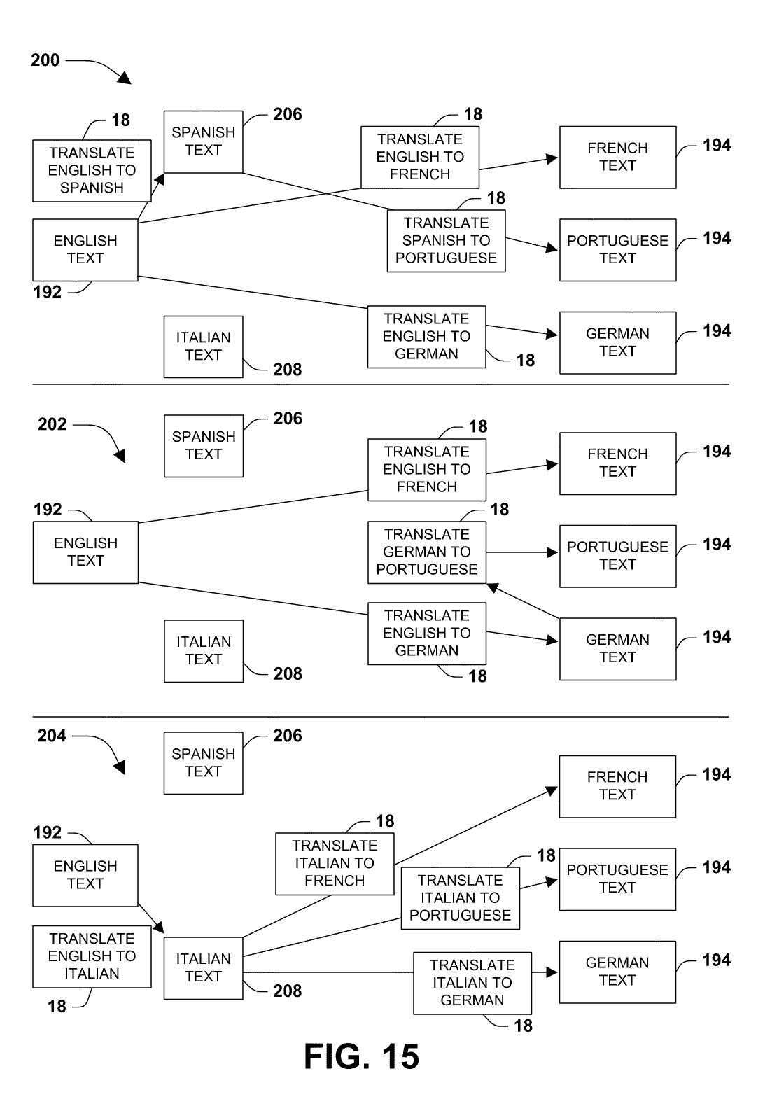

FIG. 15 illustrates three alternative sequences of agent capabilities 18 that may be available and preferable for fulfilling the tasks illustrated in FIG. 14 as compared with the single-agent-capability options. A first alternative sequence 200 may be useful if a single agent capability 18 is unavailable for translating the English language document 192 to the Portuguese text (or if this transition is too expensive, of inadequate quality, etc.) Instead, an intermediate task state may be identified, such as a Spanish text 206, and agent capabilities 18 may be identified to transition through the intermediate task state. This may be achieved by identifying a first agent transition 18 representing a translation from English to Spanish, and enabling a transition from the English language document 192 to the Spanish text 206, and a second agent transition 18 representing a translation from Spanish to Portuguese, and enabling a transition from the Spanish text 206 to the Portuguese text 194. A second alternative sequence 202 involves the use of a task end state 194 of another task 22 as the intermediate task state to reach the task end state comprising the Portuguese text 114. Because the transition to the German text 114 is already being performed for another task 22, the German text 114 may be selected as an intermediate task state, and may reach the Portuguese text 114 by identifying an agent capability 18 translating German to Portuguese. A third alternative sequence 204 involves a redirection of all tasks 26 to transition through another intermediate task state, representing an Italian text 208, and with subsequent agent capabilities 18 identified to translate from the Italian text 208 to various language texts representing the respective task end states 194 of the tasks 22. This transitional model of the task 22 and the agent capabilities 18 might yield improved alternatives, e.g., through a collective sharing and re-use of task states for a first task 22 that are already achieved in the performance of a second task.

The advantages illustrated in FIGS. 11-12 may be achieved through an adjustment of the techniques discussed herein (such as the exemplary method 50 of FIG. 4) to accommodate the transitional model of the task 22 and the agent capabilities 18. According to the adjusted technique, each task 22 is identified as having a task start state 192 and a task end state 194, and respective agent capabilities 18 and task capabilities 24 represent a transition from a first task state to a second task state. Consequently, a coalition 40 may be allocated to a task 22 by selecting a coalition of agents 16 from the agent set 15 that collectively comprise agent capabilities 18 that represent a transition sequence from the task start state 192 to the task end state 194.

While this variation of these techniques presents an expanded range of evaluative options that may yield improved results, the computational burden may also be greatly expanded due to the extended combinatorial possibilities for each task state. Moreover, some additional complexities may arise; e.g., performing a task 22 through a longer transition sequence of agent capabilities 18 may entail a potentially greater risk of unreliability (particularly if involving long chains of sequential interactions among human agents 16.) Moreover, in many scenarios, the quality of the work may degrade with each transition, such that a transition sequence involving several high-proficiency transitions may nevertheless result in comparatively low-proficiency work as output.

One technique for evaluating this transitional model involves modeling the task 22, the task states, and the agent capabilities 18 as an optimization model. One such optimization model is represented according to the mathematical formula:

maxΣᵢΣ_{e to t}_{ᵢ}fᵢ^{out}(e),

Σₑfᵢⁱⁿ(e)≦cₑ,

Σ_{e from s}_{ᵢ}fᵢⁱⁿ(e)=dᵢ,

fᵢ^{out}(e)=w(e)·fᵢⁱⁿ(e),

Σ_{w}fᵢ^{out}(w,u)=Σ_{w}fᵢⁱⁿ(u,v)u≠sᵢ, tᵢ,

This mathematical formula relies on the following notation:

sᵢ represents the task source state of a task i;

tᵢ represents the task end state of a task i;

cₑ represents a capability capacity of an agent capability of an agent, the agent capability utilized at task state e;

fᵢⁱⁿ(e) represents a performance quality of a task i entering a task state e;

fᵢ^{out}(e) represents a performance quality of a task i leaving a task state e;

dᵢ represents a starting performance quality at the task source state; and

w(e) represents a capability proficiency of an agent capability of an agent, the agent capability utilized at task state e.

An efficient application of this model may yield more efficient techniques for identifying coalitions 40 of agents 16 to be allocated to various tasks 22 according to the techniques discussed herein. As a first example, coalitions 40 may be preferentially selected having a smaller number of agent capabilities 18. This minimization of the length of the transition sequence may reduce the computational burden in evaluating this transitional model, and may also improve the reliability and timeliness of the selected performance of the task 22. As a second example, this transitional model may also enable a preferential selection of coalitions 40 to reduce the duration of the transition sequence, and hence the performance of the task 22. For example, respective agent capabilities may indicate a predicted duration for transitioning from a first task state to a second task state. The coalitions 40 may then be preferentially selected in order to minimize the predicted duration involved in performing the transition sequence.
However, those of ordinary skill in the art may devise many ways of selecting and allocating coalitions 40 to various tasks 22, including many uses and advantages of the transitional model, in accordance with the techniques discussed herein.

A general approach to the optimization of the coalescence and sequencing of human and computational resources can be characterized as the use of decision-theoretic representations and models to select and evaluate coalitions 40 to perform various tasks with the objective of maximizing expected utility. According to a decision-theoretic approach, the allocation of a coalition 40 to fulfill a particular task 22 may result in a set of expected utilities, relating to the nature of the task 22 and the nature of the coalition 40. As a first example, the expected utility may be based on the proficiency, economy, and/or expedience with which the coalition 40 may perform the task 22. As a second example, the expected utility may be based on the reliability or unreliability, or the safety or danger, involved if the particular coalition 40 is allocated to perform the task 22. As a third example, a set of potential outcomes of the fulfillment of the task 22 may be identified (e.g., a failure to perform the task 22, a partial completion of the task 22, or a full completion of the task 22 in various ways), and the expected probability and utility of each potential outcome may be weighed. These and other aspects of the task 22 and the coalition 40 may be identified and calculated as part of the expected utility of the allocation according to the decision-theoretic model. Moreover, the comparative expected utilities of various allocations of coalitions 40 to various tasks 22 of various projects 20 may be compared, and it may be desirable to apply a decision-theoretic function to select coalitions 40 in a manner that maximizes the expected utility of the tasks 22 of a project 20. Those of ordinary skill in the art may devise many uses of a decision-theoretic approach to the allocation of coalitions 40 to tasks 22 and projects 20 based on the expected utilities achieved thereby in accordance with the techniques discussed herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used in this application, the terms “component,” “module,” “system”, “interface”, and the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, those skilled in the art will recognize many modifications may be made to this configuration without departing from the scope or spirit of the claimed subject matter.

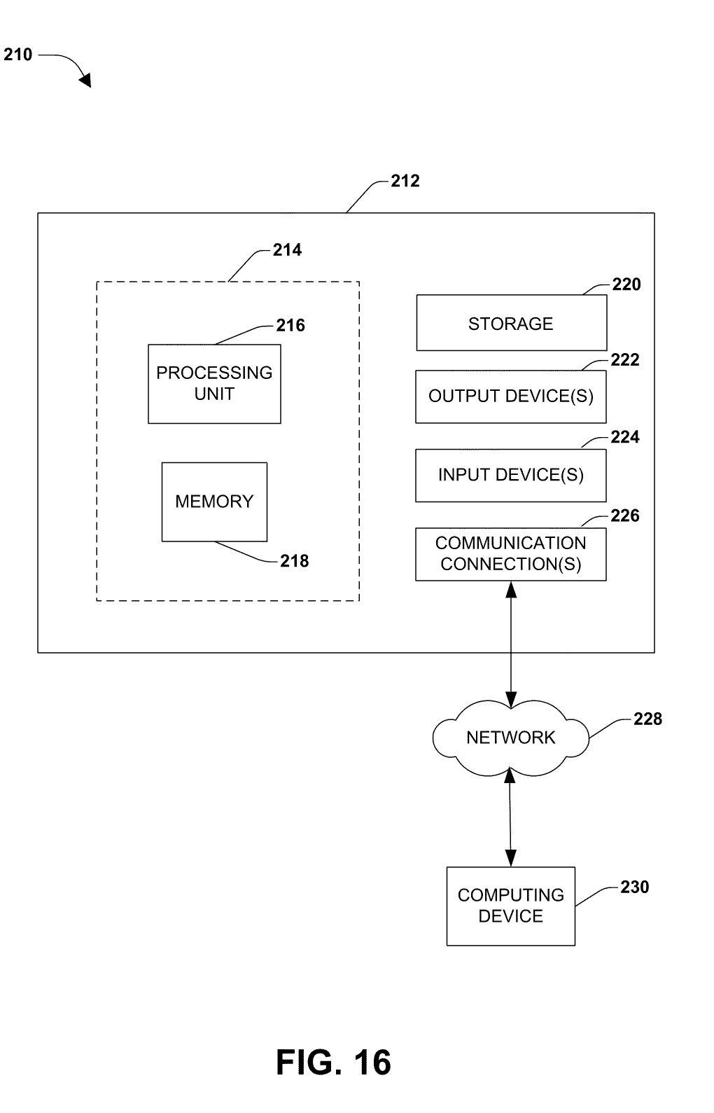

FIG. 16 and the following discussion provide a brief, general description of a suitable computing environment to implement embodiments of one or more of the provisions set forth herein. The operating environment of FIG. 16 is only one example of a suitable operating environment and is not intended to suggest any limitation as to the scope of use or functionality of the operating environment. Example computing devices include, but are not limited to, personal computers, server computers, hand-held or laptop devices, mobile devices (such as mobile phones, Personal Digital Assistants (PDAs), media players, and the like), multiprocessor systems, consumer electronics, mini computers, mainframe computers, distributed computing environments that include any of the above systems or devices, and the like.

Although not required, embodiments are described in the general context of “computer readable instructions” being executed by one or more computing devices. Computer readable instructions may be distributed via computer readable media (discussed below). Computer readable instructions may be implemented as program modules, such as functions, objects, Application Programming Interfaces (APIs), data structures, and the like, that perform particular tasks or implement particular abstract data types. Typically, the functionality of the computer readable instructions may be combined or distributed as desired in various environments.

FIG. 16 illustrates an example of a system 210 comprising a computing device 212 configured to implement one or more embodiments provided herein. In one configuration, computing device 212 includes at least one processing unit 216 and memory 218. Depending on the exact configuration and type of computing device, memory 218 may be volatile (such as RAM, for example), non-volatile (such as ROM, flash memory, etc., for example) or some combination of the two. This configuration is illustrated in FIG. 16 by dashed line 214.

In other embodiments, device 212 may include additional features and/or functionality. For example, device 212 may also include additional storage (e.g., removable and/or non-removable) including, but not limited to, magnetic storage, optical storage, and the like. Such additional storage is illustrated in FIG. 16 by storage 220. In one embodiment, computer readable instructions to implement one or more embodiments provided herein may be in storage 220. Storage 220 may also store other computer readable instructions to implement an operating system, an application program, and the like. Computer readable instructions may be loaded in memory 218 for execution by processing unit 216, for example.

The term “computer readable media” as used herein includes computer storage media. Computer storage media includes volatile and nonvolatile, removable and non-removable media implemented in any method or technology for storage of information such as computer readable instructions or other data. Memory 218 and storage 220 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 212. Any such computer storage media may be part of device 212.

Device 212 may also include communication connection(s) 226 that allows device 212 to communicate with other devices. Communication connection(s) 226 may include, but is not limited to, a modem, a Network Interface Card (NIC), an integrated network interface, a radio frequency transmitter/receiver, an infrared port, a USB connection, or other interfaces for connecting computing device 212 to other computing devices. Communication connection(s) 226 may include a wired connection or a wireless connection. Communication connection(s) 226 may transmit and/or receive communication media.

The term “computer readable media” may include communication media. Communication media typically embodies computer readable instructions or other data in a “modulated data signal” such as a carrier wave or other transport mechanism and includes any information delivery media. The term “modulated data signal” may include a signal that has one or more of its characteristics set or changed in such a manner as to encode information in the signal.

Device 212 may include input device(s) 224 such as keyboard, mouse, pen, voice input device, touch input device, infrared cameras, video input devices, and/or any other input device. Output device(s) 222 such as one or more displays, speakers, printers, and/or any other output device may also be included in device 212. Input device(s) 224 and output device(s) 222 may be connected to device 212 via a wired connection, wireless connection, or any combination thereof. In one embodiment, an input device or an output device from another computing device may be used as input device(s) 224 or output device(s) 222 for computing device 212.

Components of computing device 212 may be connected by various interconnects, such as a bus. Such interconnects may include a Peripheral Component Interconnect (PCI), such as PCI Express, a Universal Serial Bus (USB), firewire (IEEE 1394), an optical bus structure, and the like. In another embodiment, components of computing device 212 may be interconnected by a network. For example, memory 218 may be comprised of multiple physical memory units located in different physical locations interconnected by a network.

Those skilled in the art will realize that storage devices utilized to store computer readable instructions may be distributed across a network. For example, a computing device 230 accessible via network 228 may store computer readable instructions to implement one or more embodiments provided herein. Computing device 212 may access computing device 230 and download a part or all of the computer readable instructions for execution. Alternatively, computing device 212 may download pieces of the computer readable instructions, as needed, or some instructions may be executed at computing device 212 and some at computing device 230.

Various operations of embodiments are provided herein. In one embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein.

Moreover, the word “exemplary” is used herein to mean serving as an example, instance, or illustration. Any aspect or design described herein as “exemplary” is not necessarily to be construed as advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims may generally be construed to mean “one or more” unless specified otherwise or clear from context to be directed to a singular form.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure. In addition, while a particular feature of the disclosure may have been disclosed with respect to only one of several implementations, such feature may be combined with one or more other features of the other implementations as may be desired and advantageous for any given or particular application. Furthermore, to the extent that the terms “includes”, “having”, “has”, “with”, or variants thereof are used in either the detailed description or the claims, such terms are intended to be inclusive in a manner similar to the term “comprising.”

What is claimed is:

1. A method of allocating an agent set comprising agents comprising at least one agent capability to perform at least one project, respective projects comprising at least one task, respective tasks involving at least one task capability, the method using a computer having a processor and comprising:
executing on the processor instructions configured to:
while at least one task of at least one project is unfulfilled:
select a coalition comprising at least one agent in the agent set, the agents of the coalition collectively comprising agent capabilities corresponding to the task capabilities of an unfulfilled task;
allocate the coalition to fulfill the task; and
remove the agents in the coalition from the agent set.

2. The method of claim 1, the instructions configured to:
receive from at least one manager at least one project involving at least one task, and
after allocating the coalitions to fulfill the tasks of the project, notify the manager of the coalitions allocated to the tasks of the project.

3. The method of claim 1, the instructions configured to, after receiving a project from the at least one manager, identify the at least one task comprising the project.

4. The method of claim 1, the agents selected from a set of agent types comprising at least one of:
a skill agent having an agent capability representing a skill;
a sensor agent having an agent capability representing a sensory output;
an effector agent having an agent capability representing a transformative effect;
a resource agent having an agent capability representing an access to a resource; and
a task evaluation agent having an agent capability representing a logical evaluation of a task.

5. The method of claim 1, the agent set comprising:
at least one human agent asserting at least one agent capability, and
at least one automated agent configured to perform at least one agent capability.

6. The method of claim 5, selecting an agent for a coalition comprising:
for at least one human agent asserting at least one agent capability corresponding to at least one task capability of at least one task, offering the task to the human agent; and
upon receiving from at least one human agent an acceptance of the task, selecting the agent for the coalition.

7. The method of claim 5, the instructions configured to generate the agent set by:
upon receiving a request from a human agent to be added to the agent set, the human agent asserting at least one capability:
testing the human agent in the agent capability with a capability test, and
upon the human agent passing the capability test, adding the human agent to the agent set.

8. The method of claim 1, comprising: after allocating the coalition to fulfill the tasks of the projects, committing the coalitions to perform the tasks.

9. The method of claim 8, committing a human agent in a coalition to perform a task capability of the task comprising: presenting to the human agent a game involving performing the task capability.

10. The method of claim 1:
respective agent capabilities of an agent having a capability proficiency, and
selecting the coalition comprising: selecting a coalition maximizing the capability proficiencies of the agent capabilities of the agents corresponding to the task capabilities of the task.

11. The method of claim 10, at least one capability proficiency of at least one agent capability of at least one agent identified by:
training a learning function to identify capability proficiency s of agent capabilities in a proficiency training set, and
identifying the capability proficiency by applying the learning function to the at least one agent capability of the at least one agent.

12. The method of claim 1:
respective agent capabilities of an agent having a capability cost, and
selecting the coalition comprising: selecting a coalition minimizing the capability costs of the agent capabilities of the agents corresponding to the task capabilities of the task.

13. The method of claim 1:
respective agent capabilities of an agent having a capability capacity;
respective task capabilities of a task having a capability consumption;
selecting the coalition comprising: selecting a coalition comprising at least one agent in the agent set, the agents of the coalition collectively comprising agent capabilities that:
correspond to the task capabilities of the task, and
have a capability capacity satisfying the capability consumption of the task capability of the task;
allocating the coalition comprising: for respective task capabilities of the task, reducing the capability capacity of the agent capability of the agent by the capability consumption of the task capability of the task; and
removing the agents in the coalition from the agent set comprising: removing agents in the coalition having no remaining capability capacity of any agent capability from the agent set.

14. The method of claim 1:
respective tasks having a task start state to a task end state;
respective task capabilities and respective agent capabilities representing a transition from the task start state to the task end state; and
selecting the coalition comprising: selecting a coalition comprising at least one agent in the agent set, the agents of the coalition collectively comprising agent capabilities that represent a transition sequence from the task start state to the task end state.

15. The method of claim 14, the coalitions selected to maximize a performance quality of the tasks computed according to the mathematical formula:
maxΣᵢΣ_{e to t}_{ᵢ}fᵢ^{out}(e),
Σₑfᵢⁱⁿ(e)≦cₑ,
Σ_{e from s}_{ᵢ}fᵢⁱⁿ(e)=dᵢ,
fᵢ^{out}(e)=w(e)·fᵢⁱⁿ(e),
Σ_{w}fᵢ^{out}(w,u)=Σ_{w}fᵢⁱⁿ(u,v)u≠sᵢ, tᵢ,
wherein:
sᵢ represents the task source state of a task i;
tᵢ represents the task end state of a task i;
cₑ represents a capability capacity of an agent capability of an agent, the agent capability utilized at task state e;
fᵢⁱⁿ(e) represents a performance quality of a task i entering a task state e;
fᵢ^{out}(e) represents a performance quality of a task i leaving a task state e;
dᵢ represents a starting performance quality at the task source state; and
w(e) represents a capability proficiency of an agent capability of an agent, the agent capability utilized at task state e.

16. The method of claim 15:
respective agent capabilities representing a duration for transitioning from the first task state to the second task state; and
selecting the coalition comprising: selecting a coalition minimizing, for respective tasks, the duration of the transition sequence from the task start state to the task end state.

17. The method of claim 1, the instructions configured to:
for respective coalitions that may perform the task, calculate an expected utility of the task based on at least one potential task outcome of the coalition if allocated to fulfill the task; and
apply a decision-theoretic function to select a coalition maximizing the expected utility of the tasks of the project.

18. A system configured to allocate an agent set comprising agents comprising at least one agent capability to perform at least one project, respective projects comprising at least one task, respective tasks involving at least one task capability, the system comprising:
a task selecting component configured to select at least one unfulfilled task of at least one project;
a coalition selecting component configured to select a coalition comprising at least one agent in the agent set, the agents of the coalition collectively comprising agent capabilities corresponding to the task capabilities of the task selected by the task selecting component; and
an agent allocating component configured to:
allocate the coalition selected by the coalition selecting component to fulfill the task selected by the task selecting component, and
remove the agents in the coalition from the agent set.

19. The system of claim 18, comprising:
a task interpreting component configured to interpret a task received in a natural language into a formal task specification;
a task decomposition component configured to identify a subtask structure comprising at least one subtask;
a task planning component configured to invoke the task selecting component, the coalition selecting component, and the agent allocation component to, for respective subtasks, allocate a coalition to perform the subtask;
a task coordination component configured to, for respective subtasks, receive a subtask result from the coalition upon fulfilling the subtask; and
a task composition component configured to compile a task result from the subtask results.

20. A computer-readable medium comprising a set of processor-executable instructions that, when executed on a processor of a computer having access to agent set comprising agents comprising at least one agent capability having a capability proficiency and a capability cost, the agent set comprising at least one human agent asserting at least one agent capability and at least one automated agent configured to perform at least one agent capability, and the computer having access to at least one project, respective projects comprising at least one task, respective tasks involving at least one task capability, cause the processor to allocate the agents of the agent set to the tasks of the projects by:
receiving from at least one manager at least one project involving at least one task;
upon receiving a request from a human agent to be added to the agent set, the human agent asserting at least one capability:
testing the human agent in the capability with a capability test, and
upon the human agent passing the capability test, adding the human agent to the agent set;
while at least one task of at least one project is unfulfilled:
for respective coalitions that may perform the task, calculating an expected utility of a project based on at least one potential task outcome of the coalition if allocated to fulfill the task;
applying a decision-theoretic function to select a coalition maximizing the expected utility of the task, the coalition comprising at least one agent in the agent set, the agents of the coalition collectively comprising agent capabilities corresponding to the task capabilities of the task, and selecting a human agent comprising:
offering the task to the human agent; and
upon receiving from the human agent an acceptance of the task, selecting the agent for the coalition;
allocating the coalition to fulfill the task;
removing the agents in the coalition from the agent set, the coalitions selected to achieve at least one project preference selected from a set of project preferences comprising:
maximizing the capability proficiencies of the agent capabilities of the agents corresponding to the task capabilities of the task,
minimizing the capability costs of the agent capabilities of the agents corresponding to the task capabilities of the task, and
for respective tasks, minimizing agent capabilities of the coalition not corresponding to the task capabilities of the task;
after allocating the coalitions to fulfill the tasks of a project received from a manager:
committing the coalitions to perform the tasks of the project, and
notifying the manager of the coalitions allocated to the tasks of the project.
